(19) United States
(12) Patent Application Publication
(10) Pub. No.: US 2009/0040224 A1
(43) Pub. Date: Feb. 12, 2009

(54) Three-dimensional shape conversion system, three-dimensional shape conversion method, and program for conversion of three-dimensional shape

(75) Inventors: Takeo Igarashi, Tokyo (JP); Yuki Mori, Tokyo (JP)

Correspondence Address: OLIFF & BERRIDGE, PLC, P.O. BOX 320850, ALEXANDRIA, VA, 22320-4850, US

(73) Assignee: THE UNIVERSITY OF TOKYO, TOKYO (JP)

(21) Appl. No.: 12/068,075

(22) Filed: Feb. 1, 2008

(30) Foreign Application Priority Data
Aug. 6, 2007 (JP) 2007-204018

(51) Int. Cl. G06T 15/20

(52) U.S. Cl. 345/427

(57) ABSTRACT

In a computer 20 with a three-dimensional shape conversion program installed therein, a coordinate processing unit 21 obtains two-dimensional coordinate data of a contour stroke SS input through the user's operation of a mouse 50 or another suitable input unit. A 2D/3D modeling unit 22 performs two-dimensional modeling based on the obtained two-dimensional coordinate data and thereby generates two-dimensional model data regarding a two-dimensional pattern, while performing three-dimensional modeling based on the generated two-dimensional model data and generates three-dimensional model data regarding a three-dimensional shape obtained by expanding the two-dimensional pattern. A 2D model data regulator 23 adjusts the two-dimensional model data to make a corresponding contour of the three-dimensional shape defined by the three-dimensional model data substantially consistent with the input contour stroke SS.

### BACKGROUND OF THE INVENTION

1. Field of the Invention

The present invention relates to a three-dimensional shape conversion system of converting a three-dimensional shape into two dimensions, as well as to a corresponding three-dimensional shape conversion method and a program for conversion of a three-dimensional shape.

2. Description of the Prior Art

There have been great needs in various fields to convert a three-dimensional shape into two dimensions and generate two-dimensional patterns such as paper patterns and development views. There are several known techniques adopted to prepare development views for papercraft from a three-dimensional model constructed by three-dimensional modeling software: for example, the technique proposed by Mitani et al. (see Mitani, J., and Suzuki, H., 2004, Making papercraft toys from meshes using strip-based approximate unfolding. AMC Transactions on Graphics, 23(3), pp 259-263) and the technique proposed by Shatz et al. (see Shatz, I., Tal, A., and Leifman, G., 2006, Papercraft models from meshes, The Visual Computer: International Journal of Computer Graphics (Proceedings of Pacific Graphics 2006) 22, 9, pp 825-834). Julius et al. has proposed the technique of automatic area segmentation of a three-dimensional model to form a developable surface and convert the three-dimensional model to two dimensions (see Julius, D., Kraevoy, V., and Sheffer, A., 2005, D-Charts: quasi developable mesh segmentation, Computer Graphics Forum, In Proceedings of Eurographics 2005, 24(3), pp 981-990).

### SUMMARY OF THE INVENTION

These proposed techniques are adoptable to convert a three-dimensional model to two dimensions and obtain two-dimensional patterns. It is, however, not easy to model a desired three-dimensional shape by three-dimensional graphics. A three-dimensional shape formed from two-dimensional patterns generated according to the constructed three-dimensional model is often significantly different from the originally desired three-dimensional shape. In this case, reconstruction of the three-dimensional model is required. The designer's experience, expertise, and intuition are rather essential to generate two-dimensional patterns sufficiently consistent with the desired three-dimensional shape.

In the three-dimensional shape conversion system, the three-dimensional shape conversion method, and the three-dimensional shape conversion program, there would thus be a demand for facilitating generation of two-dimensional patterns consistent with the user's desired three-dimensional shape with high accuracy.

The present invention accomplishes at least part of the demands mentioned above and the other relevant demands by the following configurations applied to the three-dimensional shape conversion system, the three-dimensional shape conversion method, and the three-dimensional shape conversion program.

One aspect of the invention pertains to a three-dimensional shape conversion system constructed to convert a three-dimensional shape into two dimensions. The three-dimensional shape conversion system includes: an input unit configured to input a contour of a three-dimensional shape; a coordinate acquisition module configured to obtain two-dimensional coordinate data of the contour input via the input module; a two-dimensional modeling module configured to perform two-dimensional modeling based on the obtained two-dimensional coordinate data and thereby generate two-dimensional model data regarding a two-dimensional pattern defined by the two-dimensional coordinate data; a three-dimensional modeling module configured to perform three-dimensional modeling based on the generated two-dimensional model data and thereby generate three-dimensional model data regarding a three-dimensional shape obtained by expanding the two-dimensional pattern defined by the two-dimensional model data; and a two-dimensional model data regulator configured to adjust the generated two-dimensional model data, in order to make a corresponding contour of the three-dimensional shape defined by the three-dimensional model data substantially consistent with the input contour.

The three-dimensional shape conversion system according to one aspect of the invention is constructed to convert a three-dimensional shape into two dimensions and generate two-dimensional patterns. In response to the user's operation of the input unit for entry of a contour (outline) of a desired three-dimensional shape, the coordinate acquisition module obtains two-dimensional coordinate data of the input contour. The two-dimensional modeling module performs two-dimensional modeling based on the obtained two-dimensional coordinate data and thereby generates two-dimensional model data regarding a two-dimensional pattern defined by the two-dimensional coordinate data. The three-dimensional modeling module performs three-dimensional modeling based on the generated two-dimensional model data and thereby generates three-dimensional model data regarding a three-dimensional shape obtained by expanding the two-dimensional pattern defined by the two-dimensional model data. The three-dimensional modeling of expanding the two-dimensional pattern defined by the two-dimensional model data causes a corresponding contour of the three-dimensional shape defined by the three-dimensional model data to be generally located inside the input contour. In the three-dimensional shape conversion system, the two-dimensional data regulator accordingly adjusts the generated two-dimensional model data, in order to make the corresponding contour of the three-dimensional shape defined by the three-dimensional model data substantially consistent with the input contour. In the three-dimensional shape conversion system according to this aspect of the invention, after generation of the two-dimensional model data regarding the two-dimensional pattern corresponding to the input contour via the input unit and generation of the three-dimensional model data based on the two-dimensional model data, the adjustment of the two-dimensional model data is performed to make the corresponding contour of the three-dimensional shape defined by the three-dimensional model data sufficiently consistent with the input contour. This arrangement readily generates the two-dimensional pattern that is consistent with the user's desired three-dimensional shape with high accuracy.

In one preferable application of the three-dimensional shape conversion system according to the above aspect of the invention, the adjustment of the two-dimensional model data by the two-dimensional model data regulator and update of the three-dimensional model data based on the adjusted two-dimensional model data by the three-dimensional modeling module are repeated until the corresponding contour of the three-dimensional shape defined by the three-dimensional model data becomes basically consistent with the input contour. This arrangement enables a three-dimensional shape constructed from the generated two-dimensional pattern to be consistent with the user's desired three-dimensional shape with higher accuracy.

In another preferable application of the three-dimensional shape conversion system according to the above aspect of the invention, the two-dimensional modeling module generates two-dimensional model data with regard to a pair of two-dimensional patterns as two opposed sides relative to the input contour, and the three-dimensional modeling module generates three-dimensional model data regarding a three-dimensional shape obtained by expanding the pair of two-dimensional patterns with joint of corresponding outer circumferences. The three-dimensional shape conversion system of this application is extremely useful to design, for example, a plush toy or a balloon filled with selected fillers or with a selected fluid inside mutually joined multiple two-dimensional patterns.

In still another preferable application of the three-dimensional shape conversion system according to the above aspect of the invention, the coordinate acquisition module obtains two-dimensional coordinate data of each tentative vertex included in the corresponding contour of the three-dimensional shape defined by the three-dimensional model data in a predetermined two-dimensional coordinate system, and the two-dimensional model data regulator includes: a projection component length computation module configured to compute a projection component length of each vector, which connects each target vertex included in the input contour with a corresponding tentative vertex corresponding to the target vertex, in a normal direction of the tentative vertex, based on two-dimensional coordinate data of the tentative vertex and the target vertex; and a coordinate computation module configured to compute coordinates of each object vertex included in a contour of the two-dimensional pattern defined by the two-dimensional model data after a motion of the object vertex in a normal direction of the object vertex by the computed projection component length. This arrangement adequately transforms the two-dimensional pattern to make the corresponding contour of the three-dimensional shape defined by the three-dimensional model data closer to the input contour, while desirably reducing the operation load in adjustment of the two-dimensional model data.

In one preferable embodiment of the above application, the three-dimensional shape conversion system further has a detection module configured to compare a sum of the projection component lengths with regard to all the tentative vertexes with a preset reference value and, when the sum becomes not greater than the preset reference value, detect a consistency of the corresponding contour of the three-dimensional shape defined by the three-dimensional model data with the input contour. This arrangement enhances the accuracy of the determination whether the corresponding contour of the three-dimensional shape defined by the three-dimensional model data is consistent with the input contour.

According to one preferable embodiment of the three-dimensional shape conversion system in the above aspect of the invention, the two-dimensional modeling module divides the two-dimensional pattern defined by the two-dimensional coordinate data of the input contour into polygon meshes, and outputs coordinates of respective vertexes of the polygon meshes and length of each edge interconnecting each pair of the vertexes as the two-dimensional model data.

In one preferable application of the three-dimensional shape conversion system of the above embodiment, the three-dimensional modeling module computes coordinates of each vertex of the polygon meshes and the length of each edge interconnecting each pair of the vertexes based on the two-dimensional model data when a mesh plane formed by each edge of the polygon meshes is moved outward in a normal direction of the mesh plane under a predetermined moving restriction in the normal direction of the mesh plane and under a predetermined expansion-contraction restriction of restricting at least expansion of each edge of the polygon meshes, and outputs the computed coordinates and the computed length of each edge as the three-dimensional model data. This arrangement ensures adequate generation of the three-dimensional model data with preventing an extreme expansion of the three-dimensional shape based on the two-dimensional pattern.

In the three-dimensional shape conversion system of this application, the predetermined moving restriction may set a moving distance Δdf of a specific vertex Vi according to Equation (1) given below:

$$Δ df = α \cdot \frac{{\sum }_{f ∈ Ni} A ( f ) \cdot n ( f )}{{\sum }_{f ∈ N} A ( f )} \qquad ( 1 )$$

where A(f), n(f), and Ni respectively denote an area of a mesh plane f, a normal vector of the mesh plane f, and a set of mesh planes including the specific vertex Vi, and α represents a preset coefficient,

the predetermined expansion-contraction restriction may set a moving distance Δde of the specific vertex Vi according to Equation (2) given below:

$$Δ de = β \cdot \frac{{\sum }_{eij ∈ Ei} \{ A ( e . leftface ) + A ( e . rightface ) \} \cdot {t}_{ij}}{{\sum }_{eij ∈ Ei} \{ A ( e . leftface ) + A ( e . rightface ) \}} \qquad ( 2 )$$

where Vj, eij, Eij, A(e,leftface), A(e,rightface), and tij respectively denote a vertex connected with the specific vertex Vi by means of an edge, an edge interconnecting the specific vertex Vi with the vertex Vj, a set of edges eij intersecting the specific vertex Vi, an area of a plane located on the left of the edge eij, an area of a plane located on the right of the edge eij, and a pulling force applied from the edge eij to the vertexes Vi and Vj, β represents a preset coefficient, and the pulling force tij is defined according to Equation (3) given below:

$${t}_{ij} = \{ \begin{matrix}0.5 \cdot ( vj - vi ) \cdot \frac{\vert vi - vj \vert - {l}_{ij}}{\vert vi - vj \vert} & … & if \vert vi - vj \vert \geq {l}_{ij} \\ 0 & … & if \vert vi - vj \vert < {l}_{ij}\end{matrix} \} \qquad ( 3 )$$

where lij denotes an original edge length, and

the three-dimensional modeling module may compute three-dimensional coordinate data when all vertexes Vi are moved by the moving distance Δdf set according to Equation (1) given above and are further moved at least once by the moving distance Δde set according to Equation (2) given above. This arrangement ensures appropriate three-dimensional modeling of expanding the two-dimensional pattern. Adequate settings of the coefficients α and β effectively enhance the degree of freedom in selection of the material for constructing the two-dimensional pattern.

In another preferable embodiment of the invention, the three-dimensional shape conversion system further includes: a three-dimensional image display unit configured to display a three-dimensional image on a window thereof; a two-dimensional image display unit configured to display a two-dimensional image on a window thereof; a three-dimensional image display controller configured to control the three-dimensional image display unit to display a three-dimensional image representing the three-dimensional shape on the window, based on the three-dimensional model data; and a two-dimensional image display controller configured to control the two-dimensional image display unit to display a two-dimensional image representing the two-dimensional pattern on the window, based on the two-dimensional model data generated by the two-dimensional modeling module or the two-dimensional model data adjusted by the two-dimensional model data regulator. In the three-dimensional shape conversion system of this embodiment, the two-dimensional pattern based on the two-dimensional model data is displayed on the window of the two-dimensional image display unit, whereas the three-dimensional shape based on the three-dimensional model data is displayed on the window of the three-dimensional image display unit. This arrangement enables the user to adequately design the two-dimensional pattern corresponding to the desired three-dimensional shape by referring to the displays on the respective windows of the two-dimensional and the three-dimensional image display units.

According to one preferable application of the three-dimensional shape conversion system of the above embodiment, in response to an operation of the input unit for entry of a cutoff stroke that intersects an outer circumference of the three-dimensional image displayed on the window of the three-dimensional display unit at two different points and cuts off part of the three-dimensional image, the three-dimensional modeling module generates the three-dimensional model data to reflect a split of the three-dimensional shape defined by the three-dimensional model data by a developable surface obtained by sweep of the cutoff stroke in a specified direction to leave one side area of the developable surface remain but to eliminate the other side area of the developable surface, and the two-dimensional model data regulator adjusts the two-dimensional model data corresponding to the remaining side area of the developable surface based on the generated three-dimensional model data.

In the three-dimensional shape conversion system of this application, in response to an operation of the input unit for entry of a cutoff stroke that intersects the outer circumference of the three-dimensional image displayed on the window of the three-dimensional display unit at two different points and cuts off part of the three-dimensional image, the three-dimensional model data is generated to reflect a split of the three-dimensional shape defined by the three-dimensional model data by a developable surface obtained by sweep of the cutoff stroke in a specified direction to leave one side area of the developable surface remain but to eliminate the other side area of the developable surface. The two-dimensional model data is then adjusted corresponding to the remaining side area of the developable surface, based on the three-dimensional model data generated in response to the entry of the cutoff stroke. The three-dimensional shape conversion system of this application readily generates a two-dimensional pattern corresponding to a relatively complicated three-dimensional shape by the simple entry of the cutoff stroke to cut off part of the three-dimensional image on the window of the three-dimensional image display unit.

In one preferable configuration of the three-dimensional shape conversion system of this application, the three-dimensional modeling module generates three-dimensional model data regarding a three-dimensional shape obtained by expanding a two-dimensional pattern based on the two-dimensional model data adjusted corresponding to the remaining side area of the developable surface, and the adjustment of the two-dimensional model data by the two-dimensional model data regulator and update of the three-dimensional model data based on the adjusted two-dimensional model data by the three-dimensional modeling module are repeated until a contour corresponding to the cutoff stroke in the three-dimensional shape by the generated three-dimensional model data becomes basically consistent with the input cutoff stroke. This arrangement effectively enables the three-dimensional shape constructed from the generated two-dimensional pattern to be consistent with the user's desired three-dimensional shape with high accuracy.

According to another preferable application of the three-dimensional shape conversion system of the above embodiment, in response to an operation of the input unit for entry of an additional stroke that has a starting point and an end point on or inside of an outer circumference of the three-dimensional image displayed on the window of the three-dimensional display unit and is protruded outward from the outer circumference of the three-dimensional image, the three-dimensional modeling module generates the three-dimensional model data to reflect formation of a predetermined baseline passing through the starting point and the end point of the input additional stroke, the coordinate acquisition module obtains two-dimensional coordinate data of a vertex included in the additional stroke in a predetermined two-dimensional coordinate system set on a preset virtual plane including the starting point and the end point of the additional stroke, while obtaining two-dimensional coordinate data of a vertex included in the baseline in projection onto the virtual plane, and the two-dimensional model data regulator adjusts the two-dimensional model data corresponding to the additional stroke and the baseline, based on the obtained two-dimensional coordinate data of the vertex included in the additional stroke and the obtained two-dimensional coordinate data of the vertex included in the baseline.

In the three-dimensional shape conversion system of this application, in response to an operation of the input unit for entry of an additional stroke that has a starting point and an end point on or inside of the outer circumference of the three-dimensional image displayed on the window of the three-dimensional display unit and is protruded outward from the outer circumference of the three-dimensional image, the three-dimensional modeling module generates the three-dimensional model data to reflect formation of a predetermined baseline passing through the starting point and the end point of the input additional stroke. The coordinate acquisition module obtains the two-dimensional coordinate data of a vertex included in the additional stroke in the predetermined two-dimensional coordinate system set on a preset virtual plane including the starting point and the end point of the additional stroke, while obtaining the two-dimensional coordinate data of a vertex included in the baseline in projection onto the virtual plane. The two-dimensional model data regulator adjusts the two-dimensional model data corresponding to the additional stroke and the baseline, based on the obtained two-dimensional coordinate data of the vertex included in the additional stroke and the obtained two-dimensional coordinate data of the vertex included in the baseline. The three-dimensional shape conversion system of this application readily generates a two-dimensional pattern corresponding to a complicated three-dimensional shape with an additional protrusion by the simple entry of the additional stroke protruded from the outer circumference of the three-dimensional image on the window of the three-dimensional image display unit.

In one preferable configuration of the three-dimensional shape conversion system of this application, the baseline is a line included in a line of intersection between a surface of the three-dimensional shape and the virtual plane and extended from the starting point to the endpoint of the additional stroke. The three-dimensional shape conversion system of this configuration adds an expanded additional part having a contour corresponding to the additional stroke and the baseline to be connected with the original three-dimensional shape on the baseline, and generates a two-dimensional pattern corresponding to this additional part.

In another preferable configuration of the three-dimensional shape conversion system of this application, the baseline is a closed line including the starting point and the end point of the additional stroke and forming a predetermined planar shape. The three-dimensional shape conversion system of this configuration adds an additional part to be connected with the original three-dimensional shape via an opening corresponding to the closed line, and generates a two-dimensional pattern corresponding to this additional part.

In still another preferable configuration of the three-dimensional shape conversion system of this application, the three-dimensional modeling module generates three-dimensional model data regarding a three-dimensional shape obtained by expanding a two-dimensional pattern based on the two-dimensional model data adjusted corresponding to the additional stroke and the baseline, and the adjustment of the two-dimensional model data by the two-dimensional model data regulator and update of the three-dimensional model data based on the adjusted two-dimensional model data by the three-dimensional modeling module are repeated until a contour corresponding to the additional stroke in the three-dimensional shape defined by the three-dimensional model data becomes basically consistent with the input additional stroke. This arrangement effectively enables the three-dimensional shape constructed from the generated two-dimensional pattern to be consistent with the user's desired three-dimensional shape with high accuracy.

In one preferable configuration of the above embodiment, the three-dimensional shape conversion system further has a three-dimensional image manipulation unit operated to move a movable vertex, which is a vertex included in a seam line corresponding to connection lines of multiple two-dimensional patterns, on the window of the three-dimensional image display unit. The coordinate acquisition module obtains two-dimensional coordinate data of the movable vertex in a predetermined two-dimensional coordinate system set on a preset virtual plane based on the movable vertex and the seam line including the movable vertex, when the movable vertex is moved on the window of the three-dimensional image display unit by an operation of the three-dimensional image manipulation unit, the two-dimensional model data regulator calculates a moving distance of the movable vertex on the virtual plane based on the two-dimensional coordinate data, and adjusts the two-dimensional model data to reflect a motion of a specific vertex, which is included in the connection lines and corresponds to the movable vertex, in a normal direction of the specific vertex by the calculated moving distance, and the three-dimensional modeling module updates the three-dimensional model data based on the adjusted two-dimensional model data.

In the three-dimensional shape conversion system of this configuration, when the three-dimensional image manipulation unit is operated to move a movable vertex, which is a vertex included in a seam line corresponding to connection lines of multiple two-dimensional patterns, on the window of the three-dimensional image display unit, the coordinate acquisition module obtains two-dimensional coordinate data of the movable vertex in the predetermined two-dimensional coordinate system set on the preset virtual plane based on the movable vertex and the seam line including the movable vertex. The two-dimensional model data regulator calculates a moving distance of the movable vertex on the virtual plane based on the two-dimensional coordinate data, and adjusts the two-dimensional model data to reflect a motion of a specific vertex, which is included in the connection lines and corresponds to the movable vertex, in the normal direction of the specific vertex by the calculated moving distance. The three-dimensional modeling module updates the three-dimensional model data based on the adjusted two-dimensional model data. The three-dimensional shape conversion system of this configuration readily alters and modifies the three-dimensional shape closer to the user's desired three-dimensional shape by simply moving the movable vertex on the window of the three-dimensional image display unit and generates a two-dimensional pattern corresponding to the modified three-dimensional shape.

In another preferable configuration of the above embodiment, the three-dimensional shape conversion system further has a two-dimensional image manipulation unit operated to move a movable vertex, which is a vertex included in an outer circumference of the two-dimensional pattern, on the window of the two-dimensional image display unit. The coordinate acquisition module obtains two-dimensional coordinate data of the movable vertex in a predetermined two-dimensional coordinate system, when the movable vertex is moved on the window of the two-dimensional image display unit by an operation of the two-dimensional image manipulation unit, the two-dimensional model data regulator adjusts the two-dimensional model data to reflect a motion of the movable vertex from its original position to a position specified by the obtained two-dimensional coordinate data, and the three-dimensional modeling module updates the three-dimensional model data based on the adjusted two-dimensional model data.

In the three-dimensional shape conversion system of this configuration, when the two-dimensional image manipulation unit is operated to move a movable vertex, which is a vertex included in an outer circumference of the two-dimensional pattern on the window of the two-dimensional image display unit, the coordinate acquisition module obtains two-dimensional coordinate data of the movable vertex in the predetermined two-dimensional coordinate system. The two-dimensional model data regulator adjusts the two-dimensional model data to reflect a motion of the movable vertex from its original position to a position specified by the obtained two-dimensional coordinate data. The three-dimensional modeling module updates the three-dimensional model data based on the adjusted two-dimensional model data. The three-dimensional shape conversion system of this configuration readily alters and modifies the three-dimensional shape closer to the user's desired three-dimensional shape by simply moving the movable vertex on the window of the two-dimensional image display unit and generates a two-dimensional pattern corresponding to the modified three-dimensional shape.

According to still another preferable application of the three-dimensional shape conversion system of the above embodiment, in response to an operation of the input unit for entry of a cutting stroke that has a starting point and an end point on or inside of an outer circumference of the three-dimensional image displayed on the window of the three-dimensional image display unit and is wholly located inside the outer circumference of the three-dimensional image, the three-dimensional modeling module updates the three-dimensional model data to reflect formation of a cutting line at a position corresponding to the cutting stroke, and the two-dimensional model data regulator adjusts the two-dimensional model data based on the updated three-dimensional model data.

In the three-dimensional shape conversion system of this application, in response to an operation of the input unit for entry of a cutting stroke that has a starting point and an end point on or inside of an outer circumference of the three-dimensional image displayed on the window of the three-dimensional image display unit and is wholly located inside the outer circumference of the three-dimensional image, the three-dimensional modeling module updates the three-dimensional model data to reflect formation of a cutting line at a position corresponding to the cutting stroke. The two-dimensional model data regulator adjusts the two-dimensional model data based on the updated three-dimensional model data. The three-dimensional shape conversion system of this application adds a new connection line to the two-dimensional pattern and thereby changes the three-dimensional shape by the simple entry of the cutting stroke to make a cutting in the three-dimensional image displayed on the window of the three-dimensional image display unit. The three-dimensional shape conversion system is preferably equipped with the two-dimensional image manipulation unit configured to move a movable vertex on the window of the two-dimensional image display unit. This arrangement enables a minute change of the three-dimensional shape.

Another aspect of the invention is directed to a three-dimensional shape conversion method of converting a three-dimensional shape into two dimensions. The three-dimensional shape conversion method includes the steps of:

(a) obtaining two-dimensional coordinate data of a contour of a three-dimensional shape input by an operation of an input unit;

(b) performing two-dimensional modeling based on the obtained two-dimensional coordinate data and thereby generating two-dimensional model data regarding a two-dimensional pattern defined by the two-dimensional coordinate data;

(c) performing three-dimensional modeling based on the generated two-dimensional model data and thereby generating three-dimensional model data regarding a three-dimensional shape obtained by expanding the two-dimensional pattern defined by the two-dimensional model data; and

(d) adjusting the generated two-dimensional model data, in order to make a corresponding contour of the three-dimensional shape defined by the three-dimensional model data substantially

In the three-dimensional shape conversion method according to this aspect of the invention, after generation of the two-dimensional model data regarding the two-dimensional pattern corresponding to the input contour via the input unit and generation of the three-dimensional model data based on the two-dimensional model data, the adjustment of the two-dimensional model data is performed to make the corresponding contour of the three-dimensional shape defined by the three-dimensional model data sufficiently consistent with the input contour. This arrangement readily generates the two-dimensional pattern that is consistent with the user's desired three-dimensional shape with high accuracy.

In one preferable embodiment of the three-dimensional shape conversion method according to the above aspect of the invention, the step (d) of adjusting the two-dimensional model data and step (e) of updating the three-dimensional model data based on the two-dimensional model data adjusted in the step (d) are repeated until the corresponding contour of the three-dimensional shape defined by the three-dimensional model data becomes basically consistent with the input contour.

Still another aspect of the invention pertains to a three-dimensional shape conversion program executed to enable a computer to function as a three-dimensional shape conversion system of converting a three-dimensional shape into two dimensions. The three-dimensional shape conversion program includes: a coordinate acquisition module configured to obtain two-dimensional coordinate data of a contour of a three-dimensional shape input by an operation of an input unit; a two-dimensional modeling module configured to perform two-dimensional modeling based on the obtained two-dimensional coordinate data and thereby generate two-dimensional model data regarding a two-dimensional pattern defined by the two-dimensional coordinate data; a three-dimensional modeling module configured to perform three-dimensional modeling based on the generated two-dimensional model data and thereby generate three-dimensional model data regarding a three-dimensional shape obtained by expanding the two-dimensional pattern defined by the two-dimensional model data; and a two-dimensional model data adjustment module configured to adjust the generated two-dimensional model data, in order to make a corresponding contour of the three-dimensional shape defined by the three-dimensional model data substantially consistent with the input contour.

In the computer with the three-dimensional shape conversion program installed therein, after generation of the two-dimensional model data regarding the two-dimensional pattern corresponding to the input contour via the input unit and generation of the three-dimensional model data based on the two-dimensional model data, the adjustment of the two-dimensional model data is performed to make the corresponding contour of the three-dimensional shape defined by the three-dimensional model data sufficiently consistent with the input contour. The computer with installation of this program is used to readily generate the two-dimensional pattern that is consistent with the user's desired three-dimensional shape with high accuracy.

### BRIEF DESCRIPTION OF THE DRAWINGS

FIG. 1 schematically illustrates the configuration of a computer 20 as a three-dimensional shape conversion system with a three-dimensional shape conversion program installed therein according to one embodiment of the invention;

FIG. 2 shows one example of display on a display screen 31 of a display device 30;

FIG. 3 is a flowchart showing a basic processing routine executed by the computer 20 of the embodiment;

FIG. 4 shows a display example in a 3D image display area 33;

FIG. 5 shows a procedure of setting connectors 35;

FIG. 6 shows the procedure of setting the connectors 35;

FIG. 7 shows a display example in a 2D image display area 32;

FIG. 8 is a flowchart showing the details of a 3D modeling routine executed at step S140 in the basic processing routine;

FIG. 9 shows the processing of steps S142 and S143 in the 3D modeling routine;

FIG. 10 shows the processing of steps S144 and S145 in the 3D modeling routine;

FIG. 11 shows a display example in the 3D image display area 33 on completion of the 3D modeling routine;

FIG. 12 is a flowchart showing the details of a 2D model data adjustment routine executed at step S150 in the basic processing routine;

FIG. 13 shows the processing of step S154 in the 2D model data adjustment routine;

FIG. 14 shows the processing of step S156 in the 2D model data adjustment routine;

FIG. 15A shows a procedure of adjusting 2D model data;

FIG. 15B shows the procedure of adjusting the 2D model data;

FIG. 15C shows the procedure of adjusting the 2D model data;

FIG. 15D shows the procedure of adjusting the 2D model data;

FIG. 16 shows a display example on a display screen 31 on completion of the basic processing routine;

FIG. 17 shows another display example in the 2D image display area 32;

FIG. 18 is a flowchart showing a cutoff routine executed by the computer 20 of the embodiment;

FIG. 19 shows a display example in the 3D image display area 33;

FIG. 20 shows the processing of steps S320 and S340 in the cutoff routine;

FIG. 21 shows a display example in the 3D image display area 33 on completion of the cutoff routine;

FIG. 22 is a flowchart showing a part addition routine executed by the computer 20 of the embodiment;

FIG. 23 shows a change of a three-dimensional image 36 by execution of the part addition routine;

FIG. 24 shows the processing of step S550 in the part addition routine;

FIG. 25 shows a display example in the 3D image display area 33 during execution of the part addition routine;

FIG. 26 is a flowchart showing a 3D dragging routine executed by the computer 20 of the embodiment;

FIG. 27 shows the processing of step S710 in the 3D dragging routine;

FIG. 28 shows the processing of step S750 in the 3D dragging routine;

FIG. 29A shows a change of a three-dimensional image 36 by execution of the 3D dragging routine;

FIG. 29B shows a corresponding change of two-dimensional patterns 34 by execution of the 3D dragging routine;

FIG. 29C shows another change of the three-dimensional image 36 by execution of the 3D dragging routine;

FIG. 29D shows a corresponding change of the two-dimensional patterns 34 by execution of the 3D dragging routine;

FIG. 30A shows a change of a two-dimensional pattern 34 by execution of a 2D dragging routine;

FIG. 30B shows another change of the two-dimensional pattern 34 by execution of the 2D dragging routine;

FIG. 30C shows a further change of the two-dimensional pattern 34 by execution of the 2D dragging routine;

FIG. 31 is a flowchart showing a seam addition routine executed by the computer 20 of the embodiment;

FIG. 32A shows a display example of a three-dimensional image 36 as a trigger of the seam addition routine;

FIG. 32B shows a change of two-dimensional patterns 34 by execution of the seam addition routine;

FIG. 32C shows another change of the two-dimensional patterns 34 by execution of the seam addition routine; and

FIG. 32D shows a display example of the three-dimensional image 36 on completion of the seam addition routine.

### DESCRIPTION OF THE PREFERRED EMBODIMENTS

Some modes of carrying out the invention are described below with reference to a preferable embodiment and relevant examples accompanied with the attached drawings.

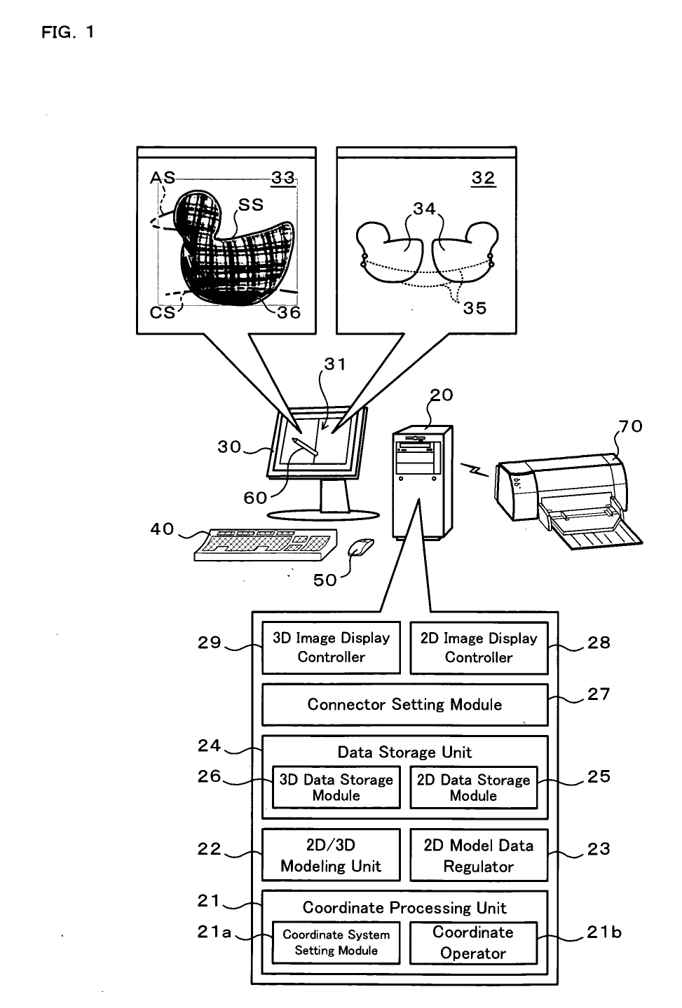

FIG. 1 schematically illustrates the configuration of a computer 20 as a three-dimensional shape conversion system according to one embodiment of the invention. The computer 20 of the embodiment is constructed as a general-purpose computer including a CPU, a ROM, a RAM, a graphics processing unit (GPU), a system bus, diverse interfaces, a memory device (hard disk drive), and an external storage device, although these elements are not specifically shown. The computer 20 is connected with a display device 30, such as a liquid crystal display, a keyboard 40 and a mouse 50 as input devices, and a printer 70. The display device 30 of the embodiment is constructed to include a liquid crystal tablet for detecting absolute coordinates on a display screen 31 specified by the user's operation of a stylus 60. A three-dimensional shape conversion program is installed in the computer 20 to convert the user's desired three-dimensional shape into two dimensions and generate two-dimensional patterns corresponding to the three-dimensional shape. The three-dimensional shape conversion program performs modeling of the user's desired three-dimensional shape in parallel with generation of resulting two-dimensional patterns (simulation), so as to make the generated two-dimensional patterns sufficiently match with the user's desired three-dimensional shape. The three-dimensional shape conversion program of the embodiment is extremely useful for designing, for example, plush toys and balloons, each of which is formed by a combination of multiple interconnected two-dimensional patterns and is filled with adequate fillers or with a selected filling gas. In the description below, the terms ‘two dimensions’ and ‘three dimensions’ may be referred to as ‘2D’ and ‘3D’ according to the requirements.

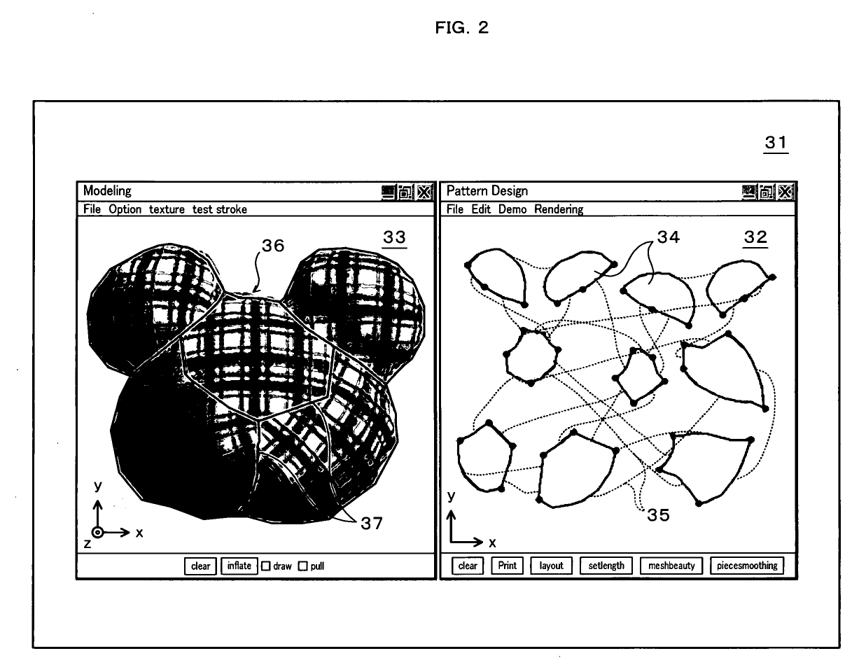

On activation of the three-dimensional shape conversion program in the computer 20, a 2D image display area 32 and a 3D image display area 33 are shown on the display screen 31 of the display device 30 as shown in FIG. 1. The user of the computer 20 may operate the mouse 50, the stylus 60, and the keyboard 40 to enter a contour stroke SS representing the contour of the user's desired three-dimensional shape in the 3D image display area 33. In response to the user's entry of the contour stroke SS, multiple two-dimensional patterns 34 corresponding to the input contour stroke SS and connectors 35 representing correlations of the contours or the outer circumferences of the multiple two-dimensional patterns 34 are displayed in the 2D image display area 32, while a three-dimensional image 36 specified by the input contour stroke SS is generated and displayed in the 3D image display area 33. The user of the computer 20 may subsequently operate the mouse 50 and the stylus 60 to enter a cutoff stroke CS (one-dot chain line in FIG. 1) for cutting an unrequired part off the three-dimensional image 36 in the 3D image display area 33 or to enter an additional stroke AS (two-dot chain line in FIG. 1) for generating an additional part protruded from the three-dimensional image 36 in the 3D image display area 33. These entries complicate the three-dimensional image 36 and give a number of two-dimensional patterns 34 corresponding to the complicated three-dimensional image 36 as shown in FIG. 2. The complicated three-dimensional image 36 displayed in the 3D image display area 33 includes seam lines 37 representing connection lines of the adjacent two-dimensional patterns 34 as shown in FIG. 2. The user of the computer 20 may further operate the mouse 50 and the stylus 60 to drag and transform the seam lines 37 displayed in the 3D image display area 33 and the outer circumferences (contours) of the two-dimensional patterns 34 displayed in the 2D image display area 32. These dragging and transforming operations alter and modify the three-dimensional image 36 to be closer to the user's desired three-dimensional shape and give the altered two-dimensional patterns 34 corresponding to the altered three-dimensional image 36. The user of the computer 20 may also enter a cutting stroke to make a cutting in the three-dimensional image 36 displayed in the 3D image display area 33. These cutting entries form new connection lines of the adjacent two-dimensional patterns 34 and thereby change the generated three-dimensional image 36. The multiple two-dimensional patterns 34 generated by the user's series of operations and displayed in the 2D image display area 32 as shown in FIG. 2 are eventually printed out with the printer 70. The printout is used as a paper pattern for creating, for example, a plush toy or a balloon. In the configuration of this embodiment, as shown in FIG. 2, an X-Y coordinate system is set as an absolute coordinate system in the 2D image display area 32, whereas an x-Y-z coordinate system is set as an absolute coordinate system in the 3D image display area 33.

Referring back to FIG. 1, the combination of the CPU, the ROM, the RAM, the GPU, the various interfaces, and the storage devices as the hardware configuration, the installed three-dimensional shape conversion program as the software configuration, or the cooperation of the hardware configuration with the software configuration constructs various functional blocks in the computer 20. The constructed functional blocks include a coordinate processing unit 21, a 2D/3D modeling unit 22, a 2D model data regulator 23, a data storage unit 24, a connector setting module 27, a 2D image display controller 28, and a 3D image display controller 29. The coordinate processing unit 21 functions to process the coordinates relevant to the two-dimensional patterns 34, the three-dimensional image 36, and the respective input strokes and includes a coordinate system setting module 21a and a coordinate operator 21b. In response to the user's entry of a desired stroke in the 3D image display area 33 or in response to the user's operation for editing the two-dimensional pattern 34 in the 2D image display area 32 or the three-dimensional image 36 in the 3D image display area 33, the coordinate system setting module 21a sets a basic coordinate system as the criterion used for computing the coordinates of each vertex included in the input stroke. The coordinate operator 21b computes the coordinates of each vertex included in the input stroke in the basic coordinate system set by the coordinate system setting module 21a and gives two-dimensional coordinate data and three-dimensional coordinate data. The 2D/3D modeling unit 22 performs known mesh modeling operations and enables both two-dimensional mesh modeling to generate two-dimensional model data based on the two-dimensional coordinate data and three-dimensional mesh modeling to generate three-dimensional model data based on the three-dimensional coordinate data. The 2D model data regulator 23 adjusts the two-dimensional model data to make the contour of a three-dimensional shape specified by the three-dimensional model data sufficiently match with the user's entered contour stroke SS, cutoff stroke CS, and additional stroke AS. The data storage unit 24 includes a 2D data storage module 25 and a 3D data storage module 26. The 2D data storage module 25 stores the two-dimensional coordinate data obtained (computed) by the coordinate processing unit 21, the two-dimensional model data output as the result of the two-dimensional mesh modeling performed by the 2D/3D modeling unit 22, and the two-dimensional model data adjusted by the 2D model data regulator 23. The 3D data storage module 26 stores the three-dimensional coordinate data obtained (computed) by the coordinate processing unit 21 and the three-dimensional model data output as the result of the three-dimensional mesh modeling performed by the 2D/3D modeling unit 22. The connector setting module 27 sets information on the connectors 35 representing the correlations of the outer circumferences (connection lines) of the respective two-dimensional patterns 34. The 2D image display controller 28 causes the two-dimensional patterns 34 to be displayed in the 2D image display area 32 based on the two-dimensional model data. The 3D image display controller 29 performs a known rendering operation of the three-dimensional model data in response to the user's image operations in the 3D image display area 33 and causes the three-dimensional image 36 of a specific texture given by the rendering operation to be displayed in the 3D image display area 33.

The computer 20 executes various processing routines during activation of the three-dimensional shape conversion program. These processing routines include a basic processing routine performed in response to the user's entry of the contour stroke SS in the 3D image display area 33, a cutoff routine performed in response to the user's entry of the cutoff stroke CS in the 3D image display area 33, a part addition routine performed in response to the user's entry of the additional stroke AS in the 3D image display area 33, a 3D dragging routine and a 2D dragging routine performed in response to the user's dragging and transforming operation of the seam line 37 and the outer circumference of the two-dimensional pattern 34, and a seam addition routine performed in response to the user's entry of the cutting stroke DS in the 3D image display area 33. These processing routines are sequentially explained below.

(Basic Processing Routine)

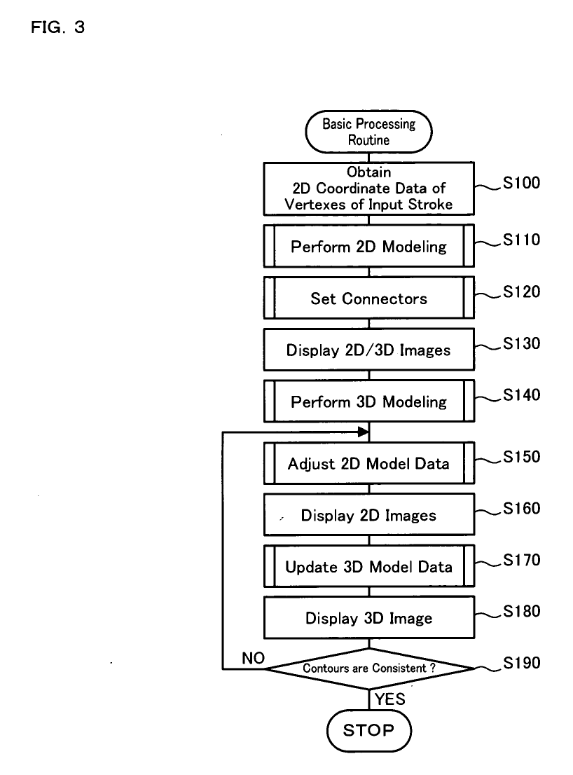

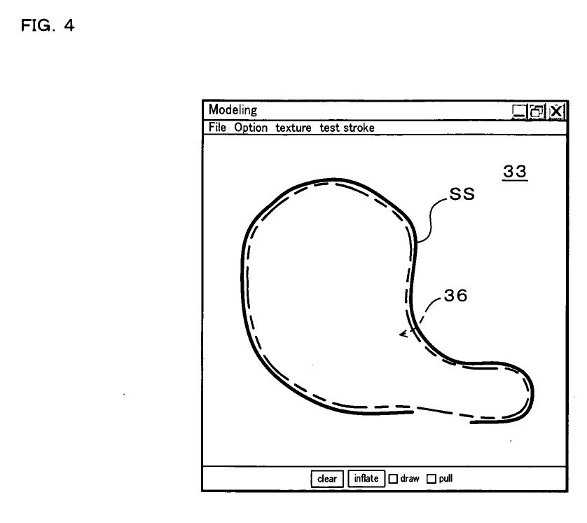

FIG. 3 is a flowchart showing a basic processing routine executed by the computer 20 of the embodiment. The basic processing routine starts in response to the user's entry of a contour stroke SS representing the contour of the user's desired three-dimensional shape in the 3D image display area 33 as shown in FIG. 4 after activation of the three-dimensional shape conversion program to show the 2D image display area 32 and the 3D image display area 33 on the display screen 31 of the display device 30. In order to prevent divergence of the operation by the self intersection of the input stroke, the basic processing routine of FIG. 3 in this embodiment is executed only in response to the user's entry of an open contour stroke SS having different starting point and end point. At the start of the basic processing routine of FIG. 3, the coordinate processing unit 21 of the computer 20 extracts coordinates of respective points constituting the input contour stroke SS in the X-Y coordinate system of the three-dimensional absolute coordinate system (the coordinate system in the unit of pixels, see FIG. 2) set in the 3D image display area 33 on the display device 30 (step S100). Among the extracted coordinates of the respective points of the input contour stroke SS, the coordinate processing unit 21 stores X-Y coordinates of specific discrete points arranged at preset intervals between a starting point and an end point of the contour stroke SS, as two-dimensional coordinate data regarding vertexes constituting the contour stroke SS, into the 2D data storage module 25 (step S100). In this embodiment, the input contour stroke SS is an open single stroke having different starting point and end point. This contour stroke SS is treated as a closed stroke, for example, by connecting the starting point with the end point by a straight line. After acquisition of the two-dimensional coordinate data of the vertexes constituting the contour stroke SS, the 2D/3D modeling unit 22 performs two-dimensional mesh modeling based on the obtained two-dimensional coordinate data (step S110). The two-dimensional mesh modeling performed at step S110 divides each two-dimensional pattern as an object of mesh division, which is specified by the two-dimensional coordinate data of the vertexes in the contour stroke SS extracted and stored at step S100, into polygon meshes (triangle meshes in this embodiment). The two-dimensional mesh modeling of step S110 then outputs information on the X-Y coordinates of vertexes of all the polygon meshes, a starting point and an end point of each edge interconnecting each pair of the vertexes, and the length of each edge, as two-dimensional model data. The two-dimensional patterns corresponding to the input contour stroke SS are the base of a paper pattern for creating, for example, a plush toy or a balloon. At step S110, the 2D/3D modeling unit 22 generates two-dimensional model data regarding a pair of bilaterally symmetric two-dimensional patterns forming opposed sides relative to one contour stroke SS. Among the vertexes of all the polygon meshes, an identifier representing an outer circumference or a contour is allocated as an attribute to the two-dimensional model data of the vertexes constituting the outer circumference (connection line) of each of the two-dimensional patterns 34. An identifier representing a terminal point is allocated as an attribute to data of specific vertexes as terminal points of the connection line (the starting point and the end point of the input contour stroke SS in this embodiment). The resulting two-dimensional model data generated and output by the 2D/3D modeling unit 22 is stored in the 2D data storage module 25. The 2D/3D modeling unit 22 adds a Z coordinate of a value ‘0’ to the X-Y coordinates of the two-dimensional model data regarding each of the two-dimensional patterns having the contour basically consistent with the contour stroke SS and accordingly generates three-dimensional model data. The generated three-dimensional model data is stored in the 3D data storage module 26.

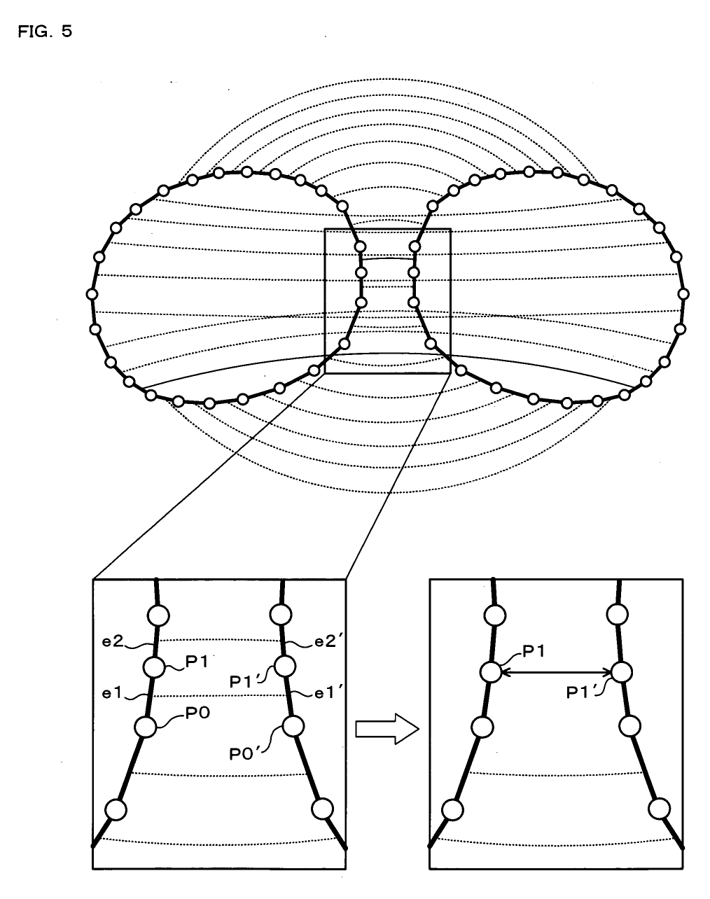

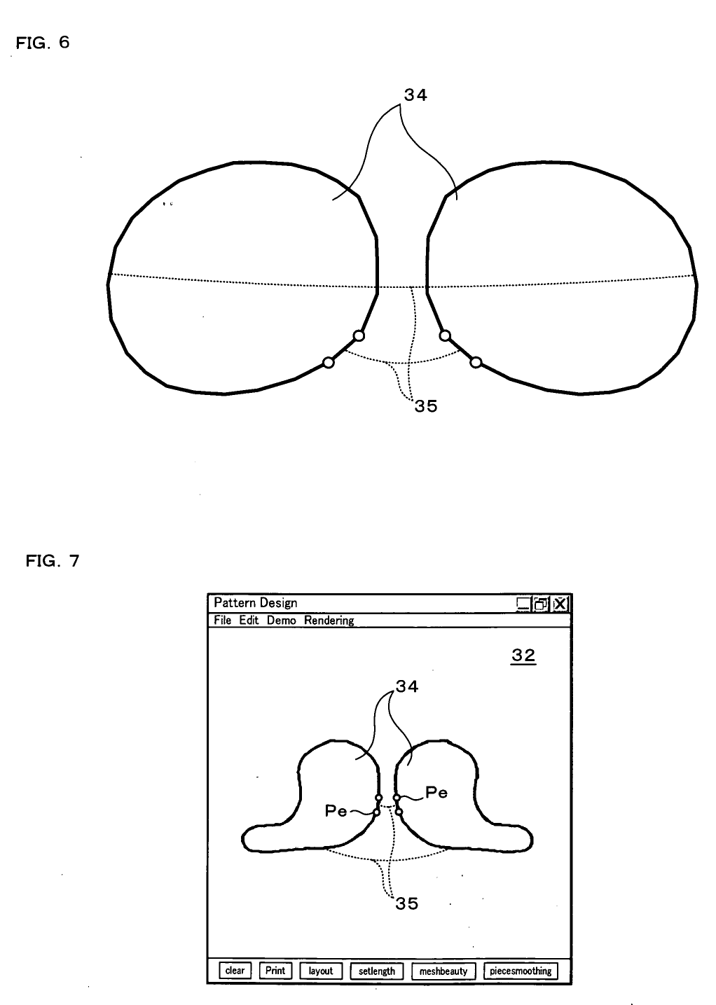

The connector setting module 27 subsequently sets information on the connectors 35 representing the correlations of the outer circumferences or the connection lines of the multiple two-dimensional patterns 34 (step S120). The two-dimensional model data generated corresponding to the input contour stroke SS regards the pair of bilaterally symmetric two-dimensional patterns as mentioned above. The connector 35 may thus be set to interconnect each pair of corresponding edges included in the pair of bilaterally symmetric two-dimensional patterns as shown in FIG. 5. Setting the connectors 35 with regard to all the interconnected pairs of the corresponding edges, however, undesirably complicates the visualization by the large number of connectors 35 displayed in the 2D image display area 32 and makes the correlations of the connection lines unclear. The processing of step S120 is performed according to the following procedure, in order to adequately set the connectors 35. The procedure of step S120 extracts one edge e1 starting from an end point P0 of the outer circumference or the connection line of one two-dimensional pattern and an edge e1'starting from a corresponding endpoint P0′ of the outer circumference or the connection line of the other two-dimensional pattern. The procedure subsequently extracts all edges adjacent to the extracted edge e1 in one two-dimensional pattern and all corresponding edges of the other two-dimensional pattern corresponding to these adjacent edges, and determines whether the extracted edges of the other two-dimensional pattern corresponding to these adjacent edges of the edge e1 are adjacent to the extracted edge e1′. Upon determination that an edge e2′ is adjacent to the extracted edge e1′ as in the illustrated example of FIG. 5, the edges e1 and e2 in one two-dimensional pattern and the corresponding edges e1′ and e2′ in the other two-dimensional pattern are respectively regarded as continuous edges. An attribute representing a correlation of a vertex P1 shared by the edges e1 and e2 to a vertex P1′ shared by the edges e1′ and e2′ by means of a connector is allocated to the two-dimensional model data regarding the vertexes P1 and P1′. This series of processing is sequentially performed at step S120 with regard to the respective pairs of adjacent edges until the object of the processing reaches the end point of the two-dimensional pattern. Eventually two connectors 35 are set for one contour stroke SS as shown in FIG. 6. The procedure of the embodiment adequately regulates the positions of the vertexes with allocation of the attributes representing the correlations by means of the connectors 35, in order to ensure a sufficient interval between the connectors 35 displayed in the 2D image display area 32.

Upon completion of the processing of steps S100 to S120, the 2D image display controller 28 displays the two-dimensional patterns 34 and the connectors 35 in a mutually non-overlapped manner in the 2D image display area 32, based on the two-dimensional model data (step S130). In parallel, the 3D image display controller 29 performs the rendering operation based on the three-dimensional model data and displays the resulting three-dimensional image 36 in the 3D image display area 33 (step S130). In the illustrated example, the pair of bilaterally symmetric two-dimensional patterns 34 having the contour basically consistent with the input contour stroke SS, the connectors 35 representing the correlations of the connection lines of the respective two-dimensional patterns 34, and terminal points Pe of the connection lines are displayed in the 2D image display area 32 as shown in FIG. 7. The three-dimensional image 36 having the contour basically consistent with the input contour stroke SS and a given specific texture (illustration is omitted from FIG. 4) is displayed in the 3D image display area 33 as shown by the two-dot chain line in FIG. 4. The three-dimensional model data generated at step S110 is identical with the two-dimensional model data generated by the two-dimensional modeling with the setting of the value ‘0’ to the Z coordinates of the respective vertexes of the polygon meshes. The specific texture given to the three-dimensional image 36 displayed in the 3D image display area 33 at step S130 is accordingly planar without the three-dimensional appearance or shading. The processing of steps S100 to S120 is executable at a high speed. The two-dimensional patterns 34 and the three-dimensional image 36 are thus respectively displayed in the 2D image display area 32 and in the 3D image display area 33 within an extremely short time period elapsed since the user's entry of the contour stroke SS in the 3D image display area 33.

The 2D/3D modeling unit 22 subsequently performs three-dimensional modeling (physical simulation) based on the three-dimensional model data generated at step S110 (this is equivalent to the two-dimensional model data of the two-dimensional patterns having the contour basically consistent with the input contour stroke SS) and thereby generates three-dimensional model data of a three-dimensional shape obtained by expanding the two-dimensional patterns defined by the two-dimensional model data generated at step S110 (step S140). The three-dimensional modeling at step S140 moves each mesh plane outward in its normal direction under a predetermined moving restriction in the normal direction and a predetermined expansion-contraction restriction of restricting at least expansion of each edge of the polygon meshes. Here the mesh plane is defined by each edge of the polygon meshes as divisions of the two-dimensional patterns having the contour basically consistent with the input contour stroke SS. In the state of moving the mesh planes under the above restrictions, the three-dimensional coordinates of the respective vertexes of the polygon meshes and the length of each edge interconnecting each pair of the vertexes are computed and output as three-dimensional model data.

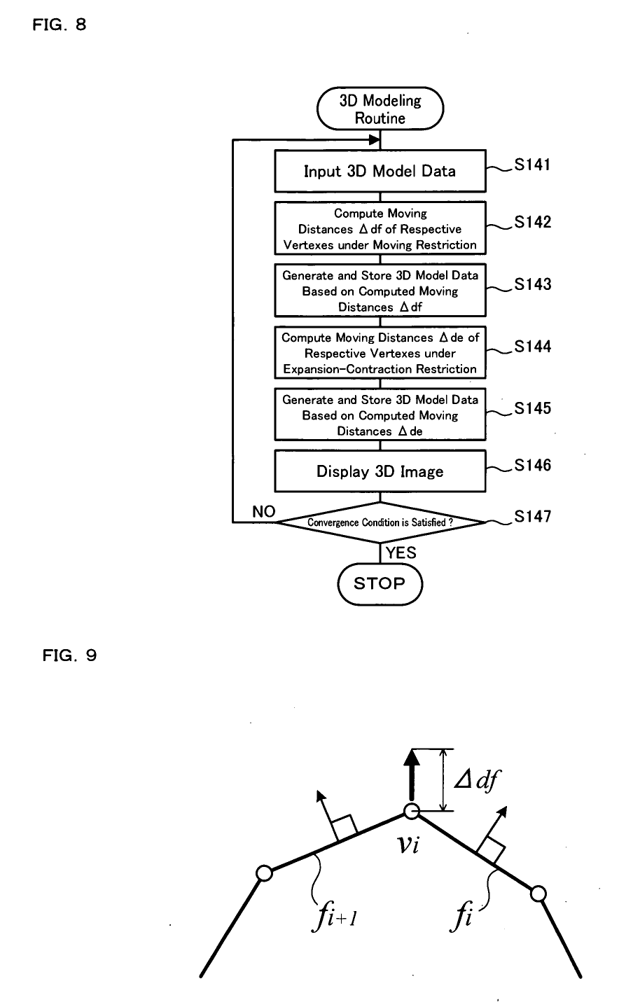

The three-dimensional modeling is explained in detail with reference to the flowchart of FIG. 8. The 2D/3D modeling unit 22 inputs the three-dimensional model data stored in the 3D data storage module 26 (step S141) and computes moving distances Δdf of all the vertexes of the polygon meshes under the moving restriction from the input three-dimensional model data (step S142). The computation of step S142 determines the moving distance Δdf of each vertex of the polygon meshes on assumption that each mesh plane is moved in its normal direction by charging adequate fillers or a selected filling gas into the internal space defined by joint of the respective connection lines of the multiple two-dimensional patterns 34 as shown in FIG. 9. A moving distance Δdf of a specific vertex Vi is determined according to Equation (1) given previously, where A(f), n(f), and Ni respectively denote an area of a mesh plane f, a normal vector of the mesh plane f, and a set of mesh planes including the vertex Vi. In this embodiment, a coefficient α included in Equation (1) is set equal to 0.02 by taking into account the characteristics of the material for constructing the two-dimensional patterns. After computation of the moving distances Δdf of the respective vertexes at step S142, the 2D/3D modeling unit 22 generates three-dimensional model data based on the three-dimensional model data input at step S141 and the computed moving distances Δdf of the respective vertexes and stores the generated three-dimensional model data in the 3D data storage module 26 (step S143). The three-dimensional model data generated here represents the three-dimensional coordinates of the respective vertexes and the edges when each vertex of the polygon meshes is moved in its normal direction by the moving distance Δdf.

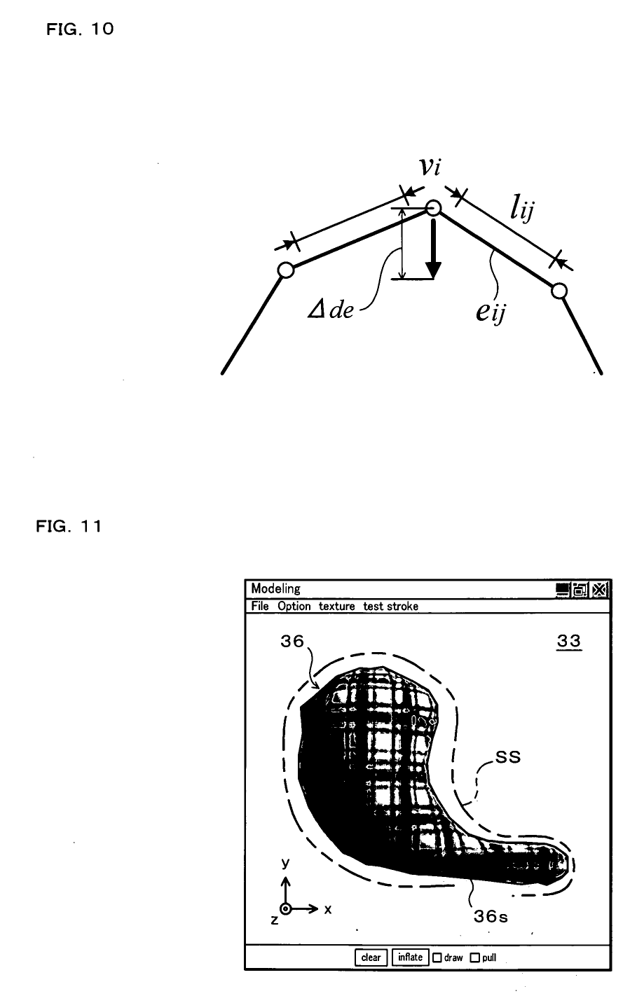

The 2D/3D modeling unit 22 subsequently computes moving distances Δde of all the vertexes of the polygon meshes under the expansion-contraction restriction from the three-dimensional model data generated at step S143 (step S144) The computation of step S144 adopts the technique proposed by Desbrun et al. (see Desbrun, M., Schroder, P., and Barr, A., 1999, Interactive animation of structured deformable objects, In Proceedings of Graphics Interface 1999, pp 1-8). As shown in FIG. 10, the computation of step S144 determines the moving distance Δde of each vertex of the polygon meshes under restriction of an outward motion of a specific vertex Vi pulled by peripheral edges on the assumption of restricting excessive expansion of the material but allowing contraction of the material for constructing the two-dimensional patterns used for creating a plush toy or a balloon. The moving distance Δde of the specific vertex Vi is determined according to Equation (2) given previously, where Vj, eij, Eij, A(e,leftface), A(e,rightface), and tij respectively denote a vertex connected with the specific vertex Vi by means of an edge, an edge interconnecting the specific vertex Vi with the vertex Vj, a set of edges eij intersecting the specific vertex Vi, an area of a plane located on the left of the edge eij, an area of a plane located on the right of the edge eij, and a pulling force applied from the edge eij to the vertexes Vi and Vj. The pulling force tij is defined according to Equation (3) given previously. In this embodiment, as clearly understood from Equation (3), the pulling force tij is applied from the edge eji to the specific vertex Vi in such a manner as to restrict the outward motion of the specific vertex Vi in only the condition of expansion of the edge. The pulling force tij is set equal to 0 in the condition of contraction of the edge. In equation (3) given above, Iij represents an original edge length. In this embodiment, a coefficient β included in Equation (2) is set equal to 1 by taking into account the characteristics of the material for constructing the two-dimensional patterns. After computation of the moving distances Δde of the respective vertexes at step S144, the 2D/3D modeling unit 22 generates three-dimensional model data based on the three-dimensional model data generated at step S143 and the computed moving distances Δde of the respective vertexes and stores the generated three-dimensional model data in the 3D data storage module 26 (step S145). The generated three-dimensional model data regards the three-dimensional coordinates of the respective vertexes and the edges when each vertex of the polygon meshes is moved in its normal direction by the moving distance Δde. After completion of the processing at step S145, the 3D image display controller 29 generates and displays a three-dimensional image 36 in the 3D image display area 33, based on the three-dimensional model data generated at step S145 (step S146). The 2D/3D modeling unit 22 then determines whether a predetermined convergence condition is satisfied (step S147). Upon dissatisfaction of the predetermined convergence condition, the processing of and after step S141 is repeated. In this embodiment, the predetermined convergence condition is satisfied after repetition of the processing of steps S141 to S146 at 30 cycles (corresponding to a time period of approximately 2 seconds). An affirmative answer at step S147 concludes the three-dimensional modeling of step S140. The processing of steps S144 and S145 may be repeated a predetermined number of times (for example, 10 times) after the processing of step S143, in order to prevent generation of an extremely expanded three-dimensional shape defined by the three-dimensional model data generated by the three-dimensional modeling of step S140.

FIG. 11 shows one example of display in the 3D image display area 33 after completion of the processing of step S140. The three-dimensional modeling of step S140 expands the two-dimensional patterns 34 having the contour basically consistent with the input contour stroke SS in the user's view direction (the Z-axis direction in the illustration). As shown in FIG. 11, a contour 36s of the three-dimensional image 36 displayed in the 3D image display area 33 corresponding to the input contour stroke SS as the result of the processing of step S140 is inconsistent with the contour stroke SS input at step S100 (shown by the two-dot chain line in FIG. 11) but is basically located inside the contour stroke SS. A plush toy or a balloon created according to a paper pattern defined by the two-dimensional patterns 34 currently displayed in the 2D image display area 32 is rather incomplete and does not have the user s desired outline. After the processing of step S140, the 2D model data regulator 23 thus executes a 2D model data adjustment routine (step S150) to make the contour 36s of the three-dimensional image 36 specified by the generated three-dimensional model data sufficiently consistent with the input contour stroke SS.

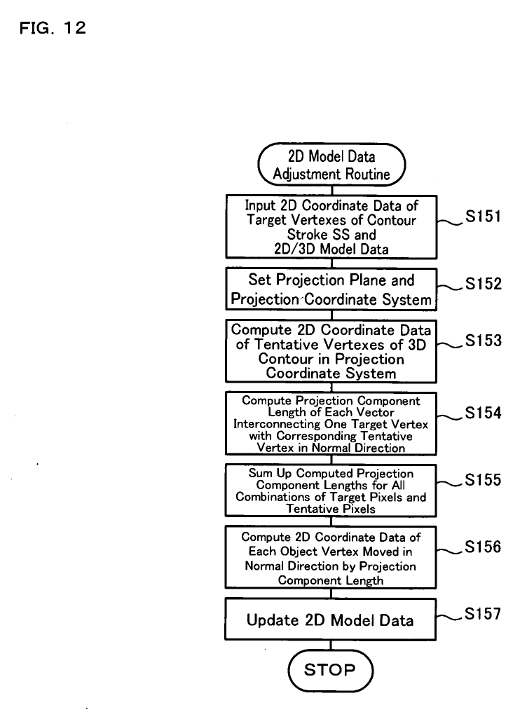

The 2D model data adjustment routine is explained with reference to the flowchart of FIG. 12. At the start of this routine, the coordinate processing unit 21 first inputs the two-dimensional coordinate data of vertexes (target vertexes) constituting the contour stroke SS stored in the 2D data storage module 25, the two-dimensional model data stored in the 2D data storage module 25, and the three-dimensional model data stored in the 3D data storage module 26 (step S151). The coordinate system setting module 21a of the coordinate processing unit 21 sets a projection plane for computing two-dimensional coordinates of vertexes constituting the contour 36s of the three-dimensional image 36 displayed in the 3D image display area 33 and sets a two-dimensional projection coordinate system for the projection plane (step S152). On the assumption that the Z direction in the 3D image display area 33 is identical with the user's view direction in the user's entry of the contour stroke SS at step S100, the processing of step S152 basically sets an X-Y plane in the 3D image display area 33 as the projection plane and an X-Y coordinate system in the 3D image display area 33 as the projection coordinate system. The user may, however, change the direction of the three-dimensional image 36 displayed in the 3D image display area 33, prior to the processing of step S150. In this case, the coordinate system setting module 21a sets a plane including the vertexes of the contour stroke SS as the projection plane and sets a horizontal axis and a vertical axis relative to the projection plane as the two-dimensional projection coordinate system. After setting the projection coordinate system, the coordinate operator 21b of the coordinate processing unit 21 computes two-dimensional coordinate data regarding each of vertexes (tentative vertexes) constituting the contour 36s of the three-dimensional image 36 in projection of the contour stroke SS onto the projection plane, based on the projection coordinate system and the three-dimensional coordinate data of the tentative vertexes in the input three-dimensional model data and stores the computed two-dimensional coordinate data in the 2D data storage module 25 (step S153). When the X-Y coordinate system in the 3D image display area 33 is set as the projection coordinate system at step S152, the two-dimensional coordinate data of each tentative vertex computed at step S153 represents an X coordinate and a Y coordinate of the three-dimensional coordinate data.

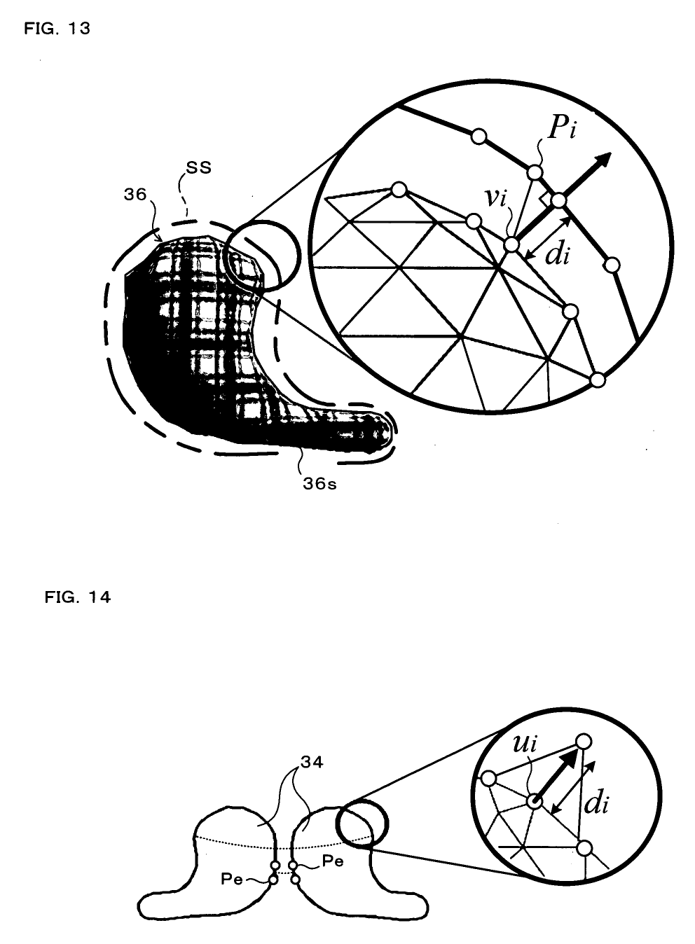

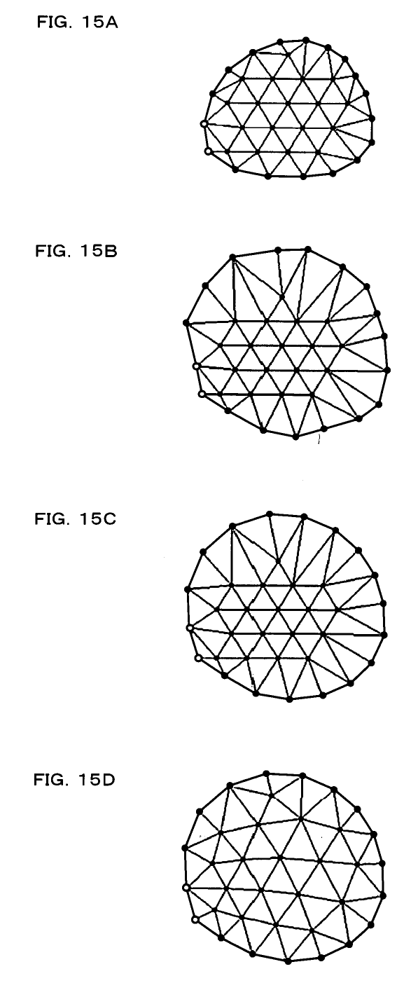

As shown in FIG. 13, the 2D model data regulator 23 subsequently computes a projection component length di of a vector, which interconnects one target vertex Pi with a corresponding tentative vertex vi corresponding to the target vertex Pi, in a normal direction of the tentative vertex vi with regard to all the combinations of the target vertexes Pi and the tentative vertexes vi, based on the two-dimensional coordinate data of the respective target vertexes Pi constituting the contour stroke SS and the two-dimensional coordinate data of the respective tentative vertexes vi (step S154). The 2D model data regulator 23 then sums up the computed projection component lengths di for all the combinations of the target vertexes Pi and the tentative vertexes vi (step S155). As shown in FIGS. 14, 15A, and 15B, the 2D model data regulator 23 computes two-dimensional coordinate data of each object vertex ui after a motion in its normal direction by the projection component length di, which is computed for a corresponding combination of the target pixel Pi and the tentative vertex vi corresponding to the object vertex ui, based on two-dimensional coordinate data of the object vertex ui at its original position and the projection component length di computed at step S154 (step S156). Here the object vertex ui represents each of vertexes constituting the outer circumference or the contour of each two-dimensional pattern 34 in the two-dimensional model data. After computation of the two-dimensional coordinate data of the respective object vertexes ui, the 2D model data regulator 23 performs known Laplacian smoothing on the computed two-dimensional coordinate data of the respective object vertexes ui (see FIGS. 15B and 15C), in order to smooth the outer circumference or the contour of the two-dimensional pattern 34. The 2D model data regulator 23 also performs known Gaussian smoothing on the two-dimensional coordinate data of remaining vertexes of the polygon meshes other than the object vertexes (see FIGS. 15C and 15D). The 2D model data regulator 23 then updates the two-dimensional model data representing the information on the X-Y coordinates of the vertexes of all the polygon meshes, the starting point and the end point of each edge interconnecting each pair of the vertexes, and the length of each edge (step S157).

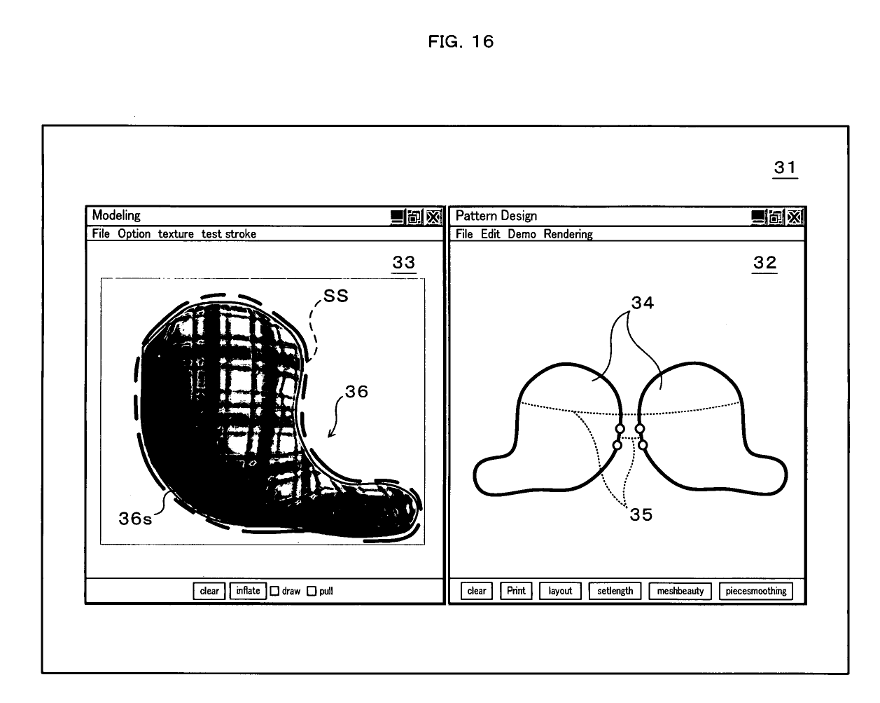

Referring back to the basic processing routine of FIG. 3, upon completion of the processing at step S150, the 2D image display controller 28 displays updated two-dimensional patterns 34 in the 2D image display area 32, based on the updated two-dimensional model data (step S160). The 2D/3D modeling unit 22 then updates the three-dimensional model data, based on the two-dimensional model data adjusted and updated at step S150 (step S170). According to a concrete procedure of step S170, the 2D/3D modeling unit 22 recalculates the three-dimensional coordinate data of the respective vertexes to make the length of each edge of the polygon meshes defined by the three-dimensional model data substantially equal to the length of a corresponding edge defined by the two-dimensional model data adjusted and updated at step S150, specifies the information on the respective edges based on the result of the recalculation, and stores the specified information as updated three-dimensional model data into the 3D data storage module 26. After the update of the three-dimensional model data at step S170, the 3D image display controller 29 displays an updated three-dimensional image 36 in the 3D image display area 33, based on the updated three-dimensional model data (step S180). After the processing of step S180, the 2D model data regulator 23 determines whether the sum of the projection component lengths di computed at step S155 is not greater than a preset reference value (step S190). When the sum of the computed projection component lengths di exceeds the preset reference value, the basic processing routine goes back to step S150 to perform the 2D model data adjustment routine again, displays updated two-dimensional patterns 34 (step S160), updates the three-dimensional model data (step S170), and displays an updated three-dimensional image 36 (step S180). Upon determination at step S190 that the sum of the computed projection component lengths di is equal to or below the preset reference value, on the other hand, the basic processing routine is terminated. On completion of this basic processing routine, a three-dimensional image 36 having a contour 36s basically consistent with the user's input contour stroke SS is displayed in the 3D image display area 33, while multiple (a pair of) two-dimensional patterns 34 corresponding to the three-dimensional image 36 are displayed with connectors 35 in the 2D image display area 32 as shown in FIG. 16.

As described above, the computer 20 of the embodiment with the three-dimensional shape conversion program installed therein converts the user's desired three-dimensional shape into two dimensions and generates two-dimensional patterns 34 according to the following procedure. In response to the user's operation of, for example, the mouse 50 or the stylus 60 for the entry of a contour stroke SS as the outline of the user's desired three-dimensional shape in the 3D image display area 33, the coordinate processing unit 21 obtains two-dimensional coordinate data of the input contour stroke SS (step S100). The 2D/3D modeling unit 22 performs two-dimensional modeling based on the obtained two-dimensional coordinate data of the input contour stroke SS and generates two-dimensional model data of two-dimensional patterns 34 defined by the two-dimensional coordinate data (step S110). The 2D/3D modeling unit 22 also performs three-dimensional modeling based on the two-dimensional model data (the three-dimensional model data practically equivalent to the two-dimensional model data) and generates three-dimensional model data of a three-dimensional shape obtained by expanding the two-dimensional patterns 34 defined by the two-dimensional model data (step S140). The three-dimensional modeling of expanding the two-dimensional patterns 34 defined by the two-dimensional model data performed at step S140, however, generally contracts the contour 36s of the three-dimensional image 36 defined by the three-dimensional model data and makes the contour 36s located inside the input contour stroke SS. The 2D model data regulator 23 then adjusts the two-dimensional model data (step S150), in order to make the contour 36s of the three-dimensional image 36 defined by the three-dimensional model data with the input contour stroke SS.

Namely the procedure of the embodiment adjusts the two-dimensional model data to make the contour 36s of the three-dimensional image 36 defined by the three-dimensional model data with the user's input contour stroke SS (step S150), after generating the two-dimensional model data of the two-dimensional patterns corresponding to the user's input contour stroke SS (step S110) and generating the three-dimensional model data based on the two-dimensional model data (step S140). This series of processing readily gives two-dimensional patterns consistent with the user's desired three-dimensional shape with high accuracy. The adjustment of the two-dimensional model data by the 2D model data regulator 23 (step S150) and the update of the three-dimensional model data based on the adjusted two-dimensional model data by the 2D/3D modeling unit 22 (step S170) are repeated until the contour 36s of the three-dimensional image 36 defined by the three-dimensional model data becomes basically consistent with the input contour stroke SS. Such repetition enables a three-dimensional shape obtained from the updated two-dimensional patterns 34 to match with the user's desired three-dimensional shape with high accuracy. The 2D/3D modeling unit 22 of the embodiment generates two-dimensional model data regarding a pair of bilaterally symmetric two-dimensional patterns 34 forming the opposed sides relative to the user's input contour stroke SS. The 2D/3D modeling unit 22 then generates three-dimensional model data regarding a three-dimensional shape obtained by expanding the pair of two-dimensional patterns 34 with joint of the respective connection lines. The computer 20 of the embodiment with the three-dimensional shape conversion program installed therein is thus extremely useful to design a plush toy or a balloon having the inside of multiple interconnected two-dimensional patterns filled with adequate fillers or with a selected filling gas.

In the adjustment of the two-dimensional model data at step S150, the coordinate processing unit 21 computes the two-dimensional coordinate data regarding the tentative vertexes vi, which constitute the contour 36s of the three-dimensional image 36 defined by the three-dimensional model data, in the projection coordinate system (step S153). The 2D/3D modeling unit 22 computes the projection component length di of each vector interconnecting one target vertex Pi with a corresponding tentative vertex vi in the normal direction of the tentative vertex vi, based on the two-dimensional coordinate data of the respective target vertexes Pi constituting the contour stroke SS and the two-dimensional coordinate data of the respective tentative vertexes vi (step S154). The 2D model data regulator 23 computes the two-dimensional coordinate data of each object vertex ui included in the outer circumference or the contour of the two-dimensional patterns 34 after a motion in the normal direction of the object vertex ui by the projection component length di, which is computed for the corresponding combination of the target pixel Pi and the tentative vertex vi corresponding to the object vertex ui (step S156). The 2D model data regulator 23 then updates the two-dimensional model data, based on the two-dimensional coordinate data of the respective object vertexes ui (step S157). This series of adjustment adequately transforms the two-dimensional patterns 34 and thereby makes the contour 36s of the three-dimensional image 36 defined by the three-dimensional model data approach to the user's input contour stroke SS. A relatively simple algorithm is used for the adjustment of the two-dimensional model data. This desirably reduces the operation load for the adjustment of the two-dimensional model data. After execution of the two-dimensional model data adjustment routine at step S150, the 2D/3D modeling unit 22 recalculates the three-dimensional coordinate data of the respective vertexes in order to make the length of each edge of the polygon meshes defined by the three-dimensional model data substantially equal to the length of a corresponding edge defined by the adjusted and updated two-dimensional model data and updates the three-dimensional model data based on the result of the recalculation (step S170). This ensures update of the three-dimensional model data within a relatively short time period. The sum of the projection component lengths di computed at step S155 with regard to all the combinations of the tentative vertexes vi and the target vertexes Pi is compared with the preset reference value (step S190). When the sum of the computed projection component lengths di is equal to or below the preset reference value, it is determined that the contour 36s of the three-dimensional image 36 defined by the three-dimensional model data is substantially consistent with the user's input contour stroke SS. The repetition of the adjustment of the two-dimensional model data (step S150) and the update of the three-dimensional model data (step S170) causes the contour 36s of the three-dimensional image 36 to gradually approach to the input contour stroke SS and decreases the sum of the computed projection component lengths di. The minimum sum of the projection component lengths di theoretically makes the contour 36s of the three-dimensional image 36 closest to the contour stroke SS. The further repetition of the adjustment of the two-dimensional model data (step S150) and the update of the three-dimensional model data (step S170) reversely increases the sum of the computed projection component lengths di. The comparison between the sum of the projection component lengths di and the preset reference value thus enables the accurate determination whether the contour 36s of the three-dimensional image 36 is substantially consistent with the input contour stroke SS.

Each mesh plane defined by each edge of the polygon meshes is moved outward in its normal direction under the moving restriction in the normal direction of the mesh plane according to Equation (1) given above and under the expansion-contraction restriction of restricting expansion of each edge of the polygon meshes according to Equation (2) given above. In the state of moving the mesh planes under the above restrictions, the 2D/3D modeling unit 22 of the embodiment computes the coordinates of the respective vertexes of the polygon meshes and the length of each edge interconnecting each pair of vertexes based on the two-dimensional model data (the three-dimensional model data substantially equivalent to the two-dimensional model data), and outputs the computed coordinates and the computed edge lengths as three-dimensional model data. This enables adequate generation of three-dimensional model data in order to prevent extreme expansion of the three-dimensional shape formed by the two-dimensional patterns. Adequately setting the coefficient α in Equation (1) and the coefficient β in Equation (2) desirably enhances the degree of freedom in selection of the material for constructing the two-dimensional patterns.

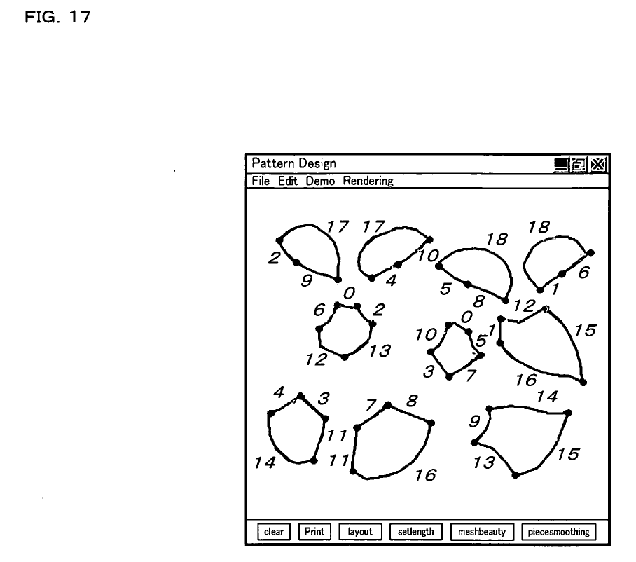

On activation of the three-dimensional shape conversion program in the computer 20, the 2D image display area 32 and the 3D image display area 33 are shown on the display screen 31 of the display device 30. The two-dimensional images or the two-dimensional patterns 34 based on the two-dimensional model data and the connectors 35 are displayed in the 2D image display area 32 by the 2D image display controller 28, while the three-dimensional image 36 based on the three-dimensional model data is displayed in the 3D image display area 33 by the 3D image display controller 29 (steps S130, S140, S160, and S180). The user refers to the displays in the 2D image display area 32 and the 3D image display area 33 and designs the two-dimensional patterns 34 corresponding to a desired three-dimensional shape. In the embodiment described above, the connectors 35 representing the correlations of the connection lines of the respective two-dimensional patterns 34 are additionally displayed in the 2D image display area 32. The display of these connectors 35 is, however, not essential. Instead of the display of the connectors 35 in the 2D image display area 32, suitable identifiers, such as figures, may be displayed in the 2D image display area 32 to show the correlations of the connection lines of the respective two-dimensional patterns 34 as shown in FIG. 17.

(Cutoff Routine)

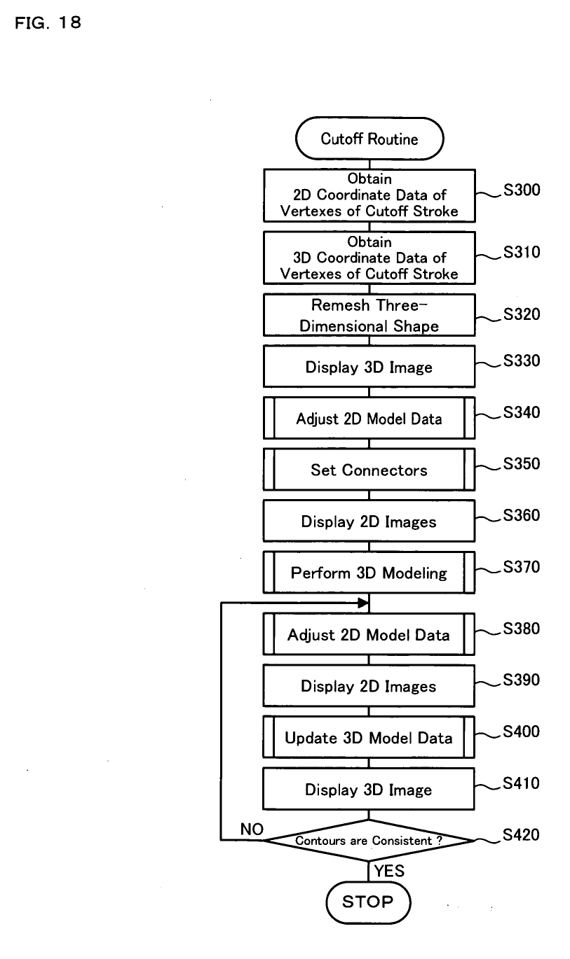

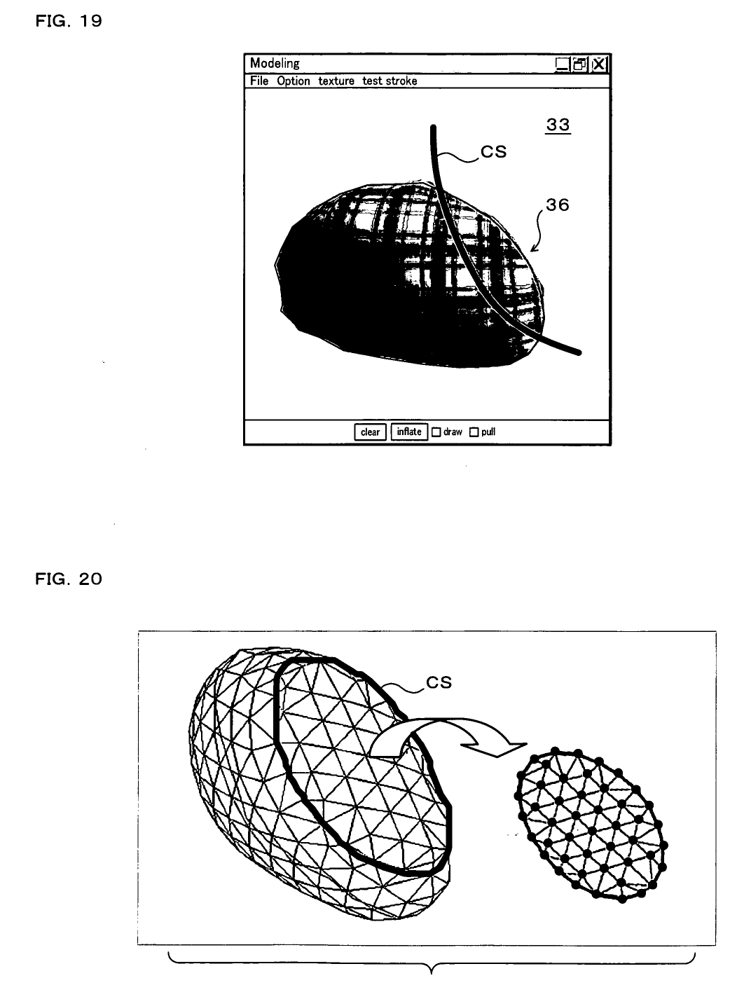

FIG. 18 is a flowchart showing a cutoff routine executed by the computer 20 of the embodiment. The cutoff routine is triggered in response to the user's entry of a cutoff stroke CS that intersects the outer circumference or the contour of the three-dimensional image 36 at two different points and thereby cuts off part of the three-dimensional image 36, which is displayed in the 3D image display area 33 by execution of the basic processing routine at least once, as shown in FIG. 19. At the start of the cutoff routine of FIG. 18, the coordinate processing unit 21 of the computer 20 extracts the coordinates of respective points constituting the input cutoff stroke CS in the X-Y coordinate system of the three-dimensional absolute coordinate system set in the 3D image display area 33 on the display device 30 and stores X-Y coordinates of specific discrete points arranged at preset intervals between a starting point and an end point of the cutoff stroke CS, among the extracted coordinates of the respective points, as two-dimensional coordinate data regarding vertexes of the cutoff stroke CS into the 2D data storage module 25 (step S300). The coordinate operator 21b of the coordinate processing unit 21 refers to the two-dimensional coordinate data of the vertexes in the cutoff stroke CS extracted and stored at step S300 and the three-dimensional model data (three-dimensional coordinates of the respective vertexes of the polygon meshes) stored in the 3D data storage module 26, computes coordinates (three-dimensional coordinates) of intersections of straight lines extended in the Z-axis direction (in the user's view direction) through the respective vertexes of the cutoff stroke CS and mesh planes defined by the three dimensional model data, and stores the computed coordinates as three-dimensional coordinate data of the vertexes constituting the cutoff stroke CS into the 3D data storage module 26 (step S310).

The 2D/3D modeling unit 22 remeshes the three-dimensional shape defined by the three-dimensional model data stored in the 3D data storage module 26, based on the three-dimensional coordinate data of the vertexes in the cutoff stroke CS computed and stored at step S310 (step S320). The remeshing of step S320 adds polygon meshes to a new cross section of the three-dimensional shape formed by a developable surface and updates the three-dimensional model data corresponding to the vertexes of the cutoff strokes CS as shown in FIG. 20. Here the developable surface is obtained by sweeping the cutoff stroke CS in the Z-axis direction (in the user's view direction) in the 3D image display area 33. In the illustrated example of FIG. 20, the original three-dimensional shape is cut by the developable surface to leave a left area on the left of the developable surface remain but to eliminate a right area on the right of the developable surface. The updated three-dimensional model data is stored in the 3D data storage module 26. The 3D image display controller 29 then displays an updated three-dimensional image 36 in the 3D image display area 33, based on the updated and stored three-dimensional model data (step S330).

The 2D model data regulator 23 adjusts the two-dimensional model data corresponding to the left area on the left of the developable surface, that is, the non-eliminated, remaining area of the original three-dimensional shape, based on the three-dimensional model data updated at step S320 (step S340). As shown in FIG. 20, the new cross section of the three-dimensional shape formed by the sweep of the cutoff stroke CS is the developable surface and is readily converted into two dimensions. At step S340, the 2D model data regulator 23 refers to the three-dimensional coordinate data regarding the vertexes of the polygon meshes added to the new cross section of the three-dimensional shape formed by the developable surface and computes two-dimensional coordinates of these vertexes in projection on a predetermined two-dimensional plane. The 2D model data regulator 23 generates two-dimensional model data with regard to the new cross section of the three-dimensional shape based on the computed two-dimensional coordinates, and adjusts the two-dimensional model data stored in the 2D data storage module 25 to include the outer circumference of the new cross section. This generates the two-dimensional model data with regard to the new two-dimensional pattern corresponding to the new cross section of the three-dimensional shape. The connector setting module 27 subsequently sets information on connectors 35 representing the correlations of the connection lines of the respective two-dimensional patterns 34 based on the adjusted two-dimensional model data in the same manner as described above with reference to step S120 in FIG. 3 (step S350). The updated two-dimensional model data is stored into the 2D data storage module 25. The 2D image display controller 28 displays the two-dimensional patterns 34 and the connectors 35 in a mutually non-overlapped manner in the 2D image display area 32, based on the updated two-dimensional model data (step S360).

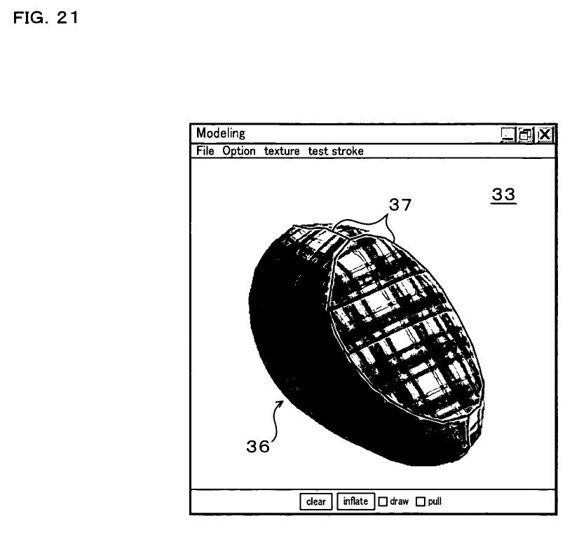

After the adjustment of the two-dimensional model data in response to the entry of the cutoff stroke CS, the 2D/3D modeling unit 22 performs the three-dimensional modeling as explained previously with reference to step S140 in FIG. 3 and generates three-dimensional model data regarding a three-dimensional shape obtained by expanding the two-dimensional patterns defined by the two-dimensional model data adjusted at step S340 (step S370). The three-dimensional modeling of step S370 basically expands outward the periphery of the new cross section of the three-dimensional shape formed by the sweep of the cutoff stroke CS. In the case of displaying the three-dimensional image 36 in the 3D image display area 33 during the three-dimensional modeling of step S370, the contour of the displayed three-dimensional image 36 is not basically consistent with the user's input cutoff stroke CS. Upon completion of the three-dimensional modeling at step S370, the 2D model data regulator 23 adjusts the two-dimensional model data as explained previously with reference to step S150 in FIG. 3, so as to make a corresponding contour (outer circumference or seam line 37) of the three-dimensional shape defined by the three-dimensional model data substantially consistent with the input cutoff stroke CS (step S380). The 2D image display controller 28 displays updated two-dimensional patterns 34 in the 2D image display area 32 based on the adjusted two-dimensional model data (step S390). The adjustment procedure of step S380 computes projection component lengths of vectors with regard to all combinations of target vertexes constituting the cutoff stroke CS and tentative vertexes constituting the seam line 37 in the three-dimensional image 36 corresponding to the cutoff stroke CS, based on two-dimensional coordinate data of the target vertexes of the cutoff stroke CS obtained at step S300 and two-dimensional coordinate data of the tentative vertexes of the seam line 37 in the projection coordinate system. The adjustment procedure subsequently computes two-dimensional coordinate data of each object vertex included in the outer circumference or the contour of the two-dimensional patterns 34 after a motion of the object vertex in its normal direction by the projection component length computed for a corresponding combination of the target vertex and the tentative vertex corresponding to the object vertex, and updates the two-dimensional model data based on the computed two-dimensional coordinate data of the respective object vertexes. The 2D/3D modeling unit 22 then updates the three-dimensional model data, based on the two-dimensional model data adjusted and updated at step S380 (step S400) in the same manner as explained above with reference to step S170 in FIG. 3. The 3D image display controller 29 displays an updated three-dimensional image 36 in the 3D image display area 33, based on the updated three-dimensional model data (step S410). After the display at step S410, the 2D model data regulator 23 determines whether the sum of the projection component lengths computed at step S380 is not greater than a preset reference value (step S420) in the same manner as explained above with reference to step S190 in FIG. 3. When the sum of the computed projection component lengths exceeds the preset reference value, the cutoff routine goes back to step S380 to perform the 2D model data adjustment routine again, displays updated two-dimensional patterns 34 (step S390), updates the three-dimensional model data (step S400), and displays an updated three-dimensional image 36 (step S410). Upon determination at step S420 that the sum of the computed projection component lengths is equal to or below the preset reference value, on the other hand, the cutoff routine is terminated. On completion of this cutoff routine, a three-dimensional image 36 having a seam line (contour) 37 corresponding to the user's input cutoff stroke CS is displayed in the 3D image display area 33, while multiple (a pair of) two-dimensional patterns 34 corresponding to the three-dimensional image 36 are displayed with connectors 35 in the 2D image display area 32 as shown in FIG. 21. In the display of FIG. 21, the three-dimensional image 36 is moved by the user to locate the new cross section forward.

As described above, in response to the user's operation of the mouse 50 and the stylus 60 for the entry of a cutoff stroke CS that intersects the outer circumference of the three-dimensional image 36 at two different points and thereby cuts off part of the three-dimensional image 36 displayed in the 3D image display area 33, the computer 20 of the embodiment with the three-dimensional shape conversion program installed therein updates the three-dimensional model data to reflect a split of the original three dimensional shape defined by the original three-dimensional model data by a developable surface to leave one side area of the developable surface remain but to eliminate the other side area of the developable surface (steps S300 to S320). Here the developable surface is obtained by sweeping the cutoff stroke CS in the Z-axis direction (in the user's view direction) in the 3D image display area 33. The 2D model data regulator 23 then adjusts the two-dimensional model data corresponding to the remaining side area of the developable surface in the three-dimensional shape defined by the updated three-dimensional model data generated in response to the user's entry of the cutoff stroke CS (step S340). The 2D/3D modeling unit 22 performs the three-dimensional modeling based on the two-dimensional model data adjusted and updated at step S340 and generates three-dimensional model data regarding a three-dimensional shape obtained by expanding the two-dimensional patterns defined by the two-dimensional model data (step S370). The adjustment of the two-dimensional model data by the 2D model data regulator 23 (step S380) and the update of the three-dimensional model data based on the adjusted two-dimensional model data by the 2D/3D modeling unit 22 (step S400) are repeated until the seam line 37 (contour) in the three-dimensional shape defined by the three-dimensional model data becomes basically consistent with the input cutoff stroke CS. Two-dimensional patterns 34 corresponding to a relatively complicated three-dimensional shape are thus obtainable by the user's simple entry of a cutoff stroke CS for cutting off part of the three-dimensional image 36 displayed in the 3D image display area 33. As mentioned above, the adjustment of the two-dimensional model data (step S360) and the update of the three-dimensional model data (step S400) are repeated until the seam line 37 in the three-dimensional image 36 becomes basically consistent with the input cutoff stroke CS. Such repetition enables a three-dimensional shape obtained from the updated two-dimensional patterns 34 to match with the user's desired three-dimensional shape with high accuracy.

(Part Addition Routine)

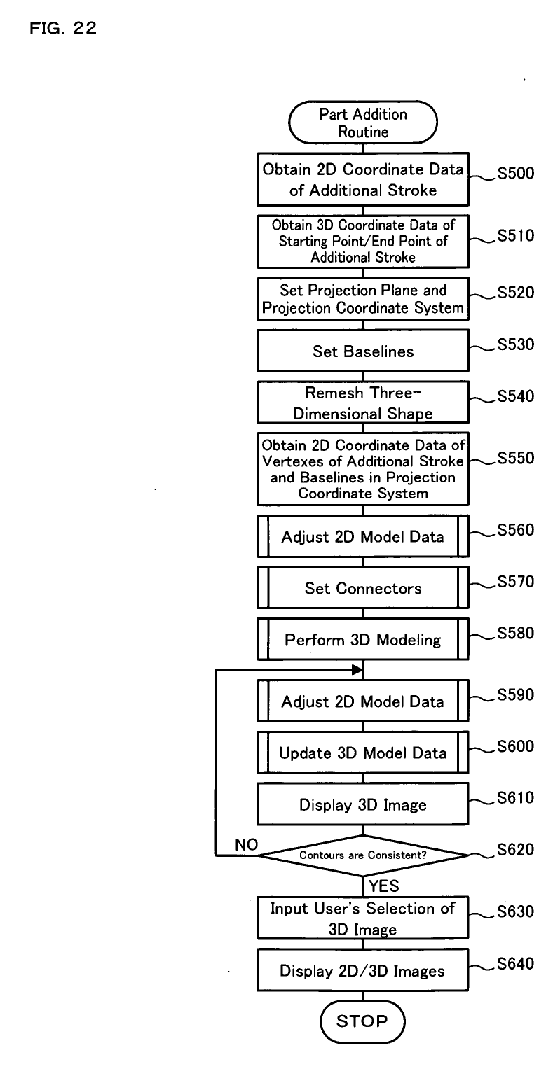

FIG. 22 is a flowchart showing a part addition routine executed by the computer 20 of the embodiment. The part addition routine is triggered in response to the user's operation of the mouse 50 and the stylus 60 for the entry of an additional stroke AS that has a starting point vs and an end point ve on or inside of the outer circumference of the three-dimensional image 36 and is protruded outward from the outer circumference of the three-dimensional image 36, which is displayed in the 3D image display area 33 by execution of the basic processing routine at least once, as shown in FIG. 23[1]. For the clarity of explanation, FIG. 23 shows the three-dimensional image 36 as the mesh model without the texture. At the start of the part addition routine of FIG. 22, the coordinate processing unit 21 of the computer 20 extracts the coordinates of respective points constituting the input additional stroke AS in the X-Y coordinate system of the three-dimensional absolute coordinate system (the coordinate system in the unit of pixels, see FIG. 2) set in the 3D image display area 33 and stores X-Y coordinates of specific discrete points arranged at preset intervals between a starting point and an endpoint of the additional stroke AS, among the extracted coordinates of the respective points, as two-dimensional coordinate data regarding vertexes of the additional stroke AS into the 2D data storage module 25 (step S500). The coordinate operator 21b of the coordinate processing unit 21 refers to the two-dimensional coordinate data of the vertexes in the additional stroke AS extracted and stored at step S500 and the three-dimensional model data (three-dimensional coordinates of the respective vertexes of the polygon meshes) stored in the 3D data storage module 26, computes coordinates (three-dimensional coordinates) of an intersection of a straight line extended in the Z-axis direction (in the user's view direction) through a vertex corresponding to the starting point of the additional stroke AS and a mesh plane defined by the three dimensional model data as well as coordinates (three-dimensional coordinates) of an intersection of a straight line extended in the Z-axis direction through a vertex corresponding to the end point of the additional stroke AS and the mesh plane defined by the three-dimensional model data, and stores the computed coordinates as three-dimensional coordinate data of the starting point and the end point of the additional stroke AS into the 3D data storage module 26 (step S510). The coordinate system setting module 21a of the coordinate processing unit 21 sets a projection plane for computing two-dimensional coordinates of the vertexes constituting the additional stroke AS based on the three-dimensional coordinate data of the starting point and the end point of the additional stroke AS computed at step S510, and sets a two-dimensional projection coordinate system for the projection plane (step S520). In the illustrated example, the procedure of step S520 sets the projection plane to a virtual plane PF that includes the starting point vs and the end point ve of the input additional stroke AS and is extended in a normal direction n of the starting point vs of the additional stroke AS, and sets the two-dimensional projection coordinate system with a straight line passing through the starting point vs and the end point ve as a horizontal axis (x′ axis) and a straight line extended from the starting point vs perpendicular to the horizontal axis (x′ axis) as a vertical axis (y′ axis) as shown in FIG. 23[1].

The 2D/3D modeling unit 22 subsequently sets baselines going through the starting point and the end point of the additional stroke AS in a three-dimensional image defined by the three-dimensional model data stored in the 3D data storage module 26 and computes three-dimensional coordinate data of vertexes constituting the baselines (step S530). In the illustrated example, there are two baselines, a baseline BL1 extended rather linearly from the starting point vs to the end point ve of the additional stroke AS as shown in FIG. 23[2] and a closed baseline BL2 including the starting point vs and the end point ve of the additional stroke AS and forming a predetermined planar shape as shown in FIG. 23[2′]. At step S530, the 2D/3D modeling unit 22 refers to the three-dimensional coordinate data of the starting point and the end point of the additional stroke AS obtained at step S510 and the three-dimensional model data (three-dimensional coordinates of the respective vertexes of the polygon meshes) stored in the 3D data storage module 26, sets discrete virtual points arranged at preset intervals on a straight line connecting the starting point vs with the end point ve of the additional stroke AS, computes coordinates (three-dimensional coordinates) of intersections of straight lines extended through the respective virtual points in parallel to the projection plane (in the normal direction of the starting point vs) and the mesh planes defined by the three-dimensional model data, and stores the computed coordinates as three-dimensional coordinate data of vertexes constituting the baseline BL1 into the 3D data storage module 26. The 2D/3D modeling unit 22 also refers to the three-dimensional coordinate data of the starting point and the end point of the additional stroke AS obtained at step S510 and the three-dimensional model data stored in the 3D data storage module 26, sets discrete virtual points arranged at preset intervals on an ellipse defined by a long axis as the straight line connecting the starting point vs with the end point ve of the additional stroke AS and a short axis of a predetermined length (for example, ¼ of the length of the long axis), computes coordinates (three-dimensional coordinates) of intersections of straight lines extended through the respective virtual points in parallel to the projection plane (in the normal direction of the starting point vs) and the mesh planes defined by the three-dimensional model data, and stores the computed coordinates as three-dimensional coordinate data of vertexes constituting the baseline BL2 into the 3D data storage module 26.

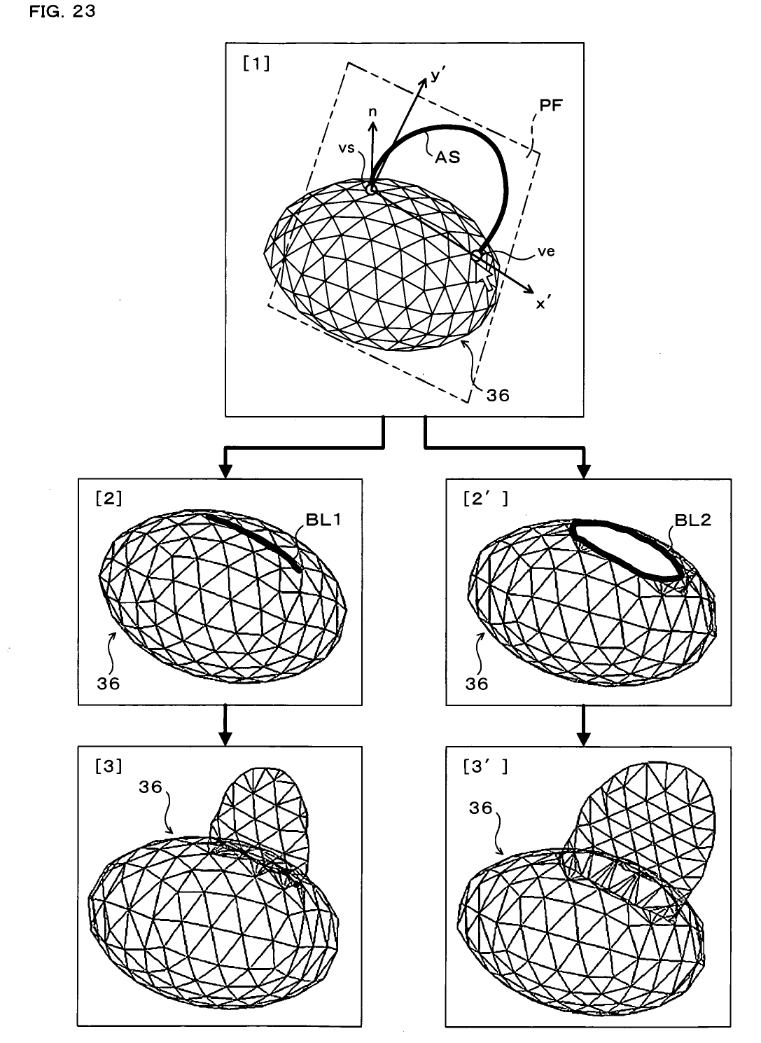

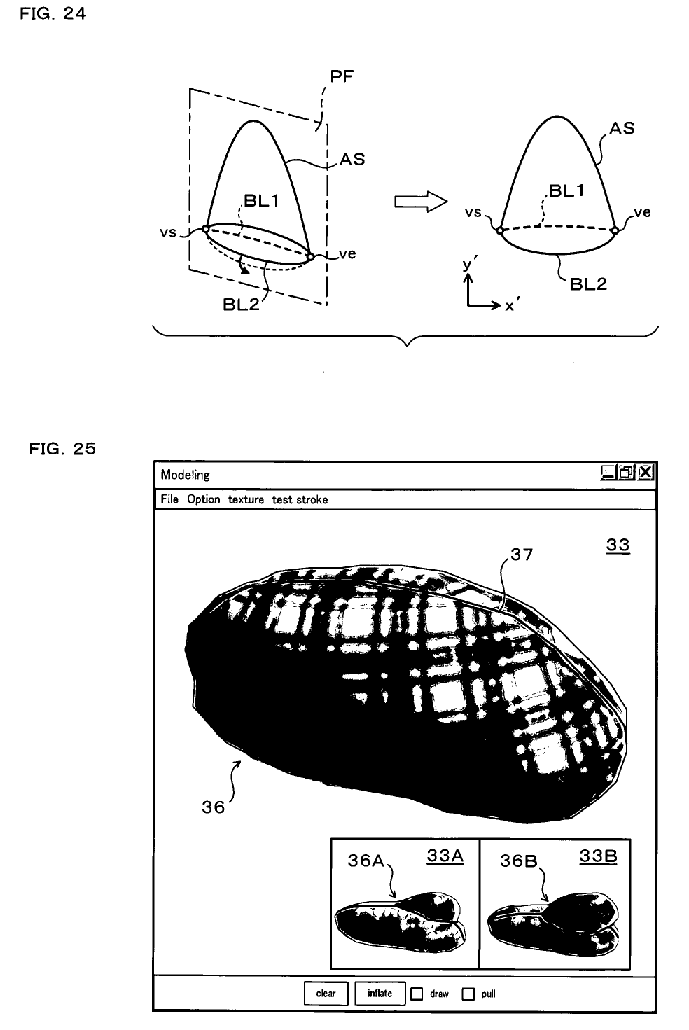

After acquisition of the three-dimensional coordinate data regarding the vertexes constituting the respective baselines BL1 and BL2 at step S530, the 2D/3D modeling unit 22 remeshes the three-dimensional shape defined by the three-dimensional model data stored in the 3D data storage module 26, based on the three-dimensional coordinate data of the vertexes constituting the baseline BL1, while remeshing the three-dimensional shape defined by the three-dimensional model data stored in the 3D data storage module 26, based on the three-dimensional coordinate data of the vertexes constituting the baseline BL2 (step S540). In the illustrated example, upon completion of the processing at step S540, the three-dimensional model data are updated corresponding to the vertexes constituting the baseline BL1 and are stored in the 3D data storage module 26 as shown in FIG. 23[2], while three-dimensional model data are generated corresponding to the vertexes constituting the baseline BL2 to form an opening in the original three-dimensional shape by the baseline BL2 and are stored in the 3D data storage module 26 as shown in FIG. 23[2′]. After the remeshing of step S540, the coordinate operator 21b of the coordinate processing unit 21 computes two-dimensional coordinate data of the respective vertexes in projection of the additional stroke AS and the baseline BL1 onto the projection plane PF in the projection coordinate system, based on the three-dimensional coordinate data of the vertexes of the additional stroke AS and the baseline BL1, and stores the computed two-dimensional coordinate data into the 2D data storage module 25 (step S550). At step S550, the coordinate operator 21b also computes two-dimensional coordinate data of the respective vertexes in projection of the additional stroke AS and the baseline BL2 onto the projection plane PF in the projection coordinate system, based on the three-dimensional coordinate data of the vertexes of the additional stroke AS and the baseline BL2, and stores the computed two-dimensional coordinate data into the 2D data storage module 25. The two-dimensional coordinate data on the baseline BL2 obtained here regard the coordinates of the respective vertexes rotated by 90 degrees relative to the projection plane as shown in FIG. 24.

The 2D model data regulator 23 then adjusts the two-dimensional model data corresponding to the additional stroke AS and the baselines BL1 and BL2, based on the two-dimensional coordinate data of the vertexes of the additional stroke AS and the baselines BL1 and BL2 in the projection coordinate system obtained at step S550 (step S560). At step S560, the 2D model data regulator 23 generates two-dimensional model data regarding a new part corresponding to the additional stroke AS, based on the two-dimensional coordinate data of the vertexes of the additional stroke AS and the baselines BL1 and BL2 in the projection coordinate system, while adjusting the two-dimensional model data stored in the 2D data storage module 25 to be consistent with connection lines of the new part and the original three-dimensional shape, based on the two-dimensional coordinate data of the vertexes of the baselines BL1 and BL2 in the projection coordinate system. Such adjustment generates two-dimensional model data regarding an updated two-dimensional pattern including the new part. The connector setting module 27 subsequently sets information on connectors 35 representing the correlations of the connection lines of the respective two-dimensional patterns 34 based on the adjusted two-dimensional model data in the same manner as described above with reference to step S120 in FIG. 3 (step S570) The 2D/3D modeling unit 22 then performs the three-dimensional modeling as explained previously with reference to step S140 in FIG. 3 and generates three-dimensional model data regarding a three-dimensional shape obtained by expanding the two-dimensional patterns defined by the adjusted two-dimensional model data (step S580).

During execution of the three-dimensional modeling at step S580, sub-windows 33A and 33B are opened with the display of the original three-dimensional image 36 prior to the user's entry of the additional stroke AS in the 3D image display area 33 as shown in FIG. 25. A three-dimensional image 36A with regard to the baseline BL1 and a three-dimensional image 36B with regard to the baseline BL2 are respectively shown in the sub-window 33A and in the sub-window 33B. The three-dimensional modeling of step S580 basically expands outward the periphery of the new part corresponding to the additional stroke AS in the three-dimensional image (see FIG. 23[2′] and FIG. 23[3′]). In the case of displaying the three-dimensional image 36 in the 3D image display area 33 during the three-dimensional modeling of step S580, the contour (outer circumference or seam line 37) of the displayed three-dimensional image 36 is not basically consistent with the user's input additional stroke AS. Upon completion of the three-dimensional modeling at step S580, the 2D model data regulator 23 adjusts the two-dimensional model data as explained previously with reference to step S150 in FIG. 3, so as to make a corresponding contour of the three-dimensional shape defined by the three-dimensional model data substantially consistent with the input additional stroke AS (step S590). The adjustment procedure of step S590 computes projection component lengths of vectors with regard to all combinations of target vertexes constituting the additional stroke AS and tentative vertexes constituting the outer circumference (seam line 37) of the three-dimensional image 36 corresponding to the additional stroke AS, based on two-dimensional coordinate data of the target vertexes of the additional stroke AS in the projection coordinate system obtained at step S550 and two-dimensional coordinate data of the tentative vertexes of the seam line 37 in the projection coordinate system. The adjustment procedure subsequently computes two-dimensional coordinate data of each object vertex included in the outer circumference or the contour of the two-dimensional patterns 34 after a motion of the object vertex in its normal direction by the projection component length computed for a corresponding combination of the target vertex and the tentative vertex corresponding to the object vertex, and updates the two-dimensional model data based on the computed two-dimensional coordinate data of the respective object vertexes. The 2D/3D modeling unit 22 then updates the three-dimensional model data, based on the adjusted and updated two-dimensional model data (step S600) in the same manner as explained above with reference to step S170 in FIG. 3. The 3D image display controller 29 displays updated three-dimensional images 36A and 36B in the respective sub-windows 33A and 33B, based on the updated three-dimensional model data (step S610). After the display at step S610, the 2D model data regulator 23 determines whether the sum of the projection component lengths computed at step S590 is not greater than a preset reference value (step S620) in the same manner as explained above with reference to step S190 in FIG. 3. When the sum of the computed projection component lengths exceeds the preset reference value, the part addition routine goes back to step S590 to perform the 2D model data adjustment routine again, updates the three-dimensional model data (step S600), and displays updated three-dimensional images 36A and 36B (step S610). Upon determination at step S620 that the sum of the computed projection component lengths is equal to or below the preset reference value, on the other hand, the repeated processing of steps S590 to S610 is terminated. When the user selects (clicks) a desired image between the three-dimensional images 36A and 36B displayed in the respective sub-windows 33A and 33B (step S630), the 2D image display controller 28 displays two-dimensional patterns 34 in the 2D image display area 32 based on two-dimensional model data corresponding to the user s selected three-dimensional image 36A or 36B (step S640). In parallel, the 3D image display controller 29 closes the sub-windows 33A and 33B and displays a resulting three-dimensional image 36 (equivalent to the user's selected three-dimensional image 36A or 36B) in the 3D image display area 33 based on the three-dimensional model data (step S640). The part addition routine is then terminated.

As described above, in the computer 20 of the embodiment with the three-dimensional shape conversion program installed therein, in response to the user's operation of the mouse 50 and the stylus 60 for the entry of an additional stroke AS that has a starting point vs and an end point ve on or inside of the outer circumference of the three-dimensional image 36 and is protruded outward from the outer circumference of the three-dimensional image 36 displayed in the 3D image display area 33, the 2D/3D modeling unit 22 updates the three-dimensional model data corresponding to the baselines BL1 and BL2 set to pass through the starting point vs and the end point ve of the additional stroke AS (steps S530 and S540). The coordinate operator 21b of the coordinate processing unit 21 obtains two-dimensional coordinate data of vertexes constituting the additional stroke AS in the projection coordinate system set for a projection plane PF including the starting point vs and the end point ve of the additional stroke AS, as well as two-dimensional coordinate data of vertexes constituting the baselines BL1 and BL2 in projection of the baselines BL1 and BL2 onto the projection plane PF (step S550). The 2D model data regulator 23 adjusts the two-dimensional model data corresponding to the additional stroke AS and the baselines BL1 and BL2, based on the two-dimensional coordinate data of the vertexes constituting the additional stroke AS and the vertexes constituting the baselines BL1 and BL2 (step S560). The 2D/3D modeling unit 22 performs the three-dimensional modeling based on the two-dimensional model data adjusted and updated at step S560 and generates three-dimensional model data regarding a three-dimensional shape obtained by expanding the two-dimensional patterns defined by the two-dimensional model data (step S580). The adjustment of the two-dimensional model data by the 2D model data regulator 23 (step S590) and the update of the three-dimensional model data based on the adjusted two-dimensional model data by the 2D/3D modeling unit 22 (step S600) are repeated until the outer circumference (seam line 37) in the three-dimensional shape defined by the three-dimensional model data becomes basically consistent with the input additional stroke AS.

Two-dimensional patterns 34 corresponding to a relatively complicated three-dimensional shape including a projection are thus obtainable by the user's simple entry of an additional stroke AS to be protruded from the three-dimensional image 36 displayed in the 3D image display area 33. As mentioned above, the adjustment of the two-dimensional model data (step S590) and the update of the three-dimensional model data (step S600) are repeated until the outer circumference (seam line 37) in the three-dimensional image 36 becomes basically consistent with the input additional stroke AS. Such repetition enables a three-dimensional shape obtained from the updated two-dimensional patterns 34 to match with the user's desired three-dimensional shape with high accuracy. The baseline BL1 set at step S530 is a line that is extended from the starting point vs to the end point ve of the additional stroke AS and included in the line of intersection between the surface (mesh plane) of the three-dimensional shape and the projection plane PF. A protruded part having the contour corresponding to the additional stroke AS and the baseline BL1 is then added to the original three-dimensional shape to be connected with the original three-dimensional shape on the baseline BL1, and the two-dimensional patterns 34 are obtained corresponding to this additional protruded part. The baseline BL2 set at step S530 is a closed line including the starting point vs and the end point ve of the additional stroke AS and forming a predetermined planar shape (a quasi elliptical shape in the embodiment). A protruded part having the contour corresponding to the additional stroke AS and the baseline BL2 is then added to the original three-dimensional shape to be connected with the original three-dimensional shape via the opening corresponding to the closed line, and the two-dimensional patterns 34 are obtained corresponding to this additional protruded part. Both the three-dimensional image 36A based on the baseline BL1 and the three-dimensional image 36B based on the baseline BL2 are displayed in the 3D image display area 33. This enables the user to select a desired three-dimensional image between the displayed two three-dimensional images 36A and 36B. This arrangement desirably enhances the user's convenience in design of a plush toy or a balloon.

The procedure of the embodiment sets the baselines in response to the user's entry of the additional stroke AS. This is, however, not restrictive. One modification may adopt the technique proposed by Igarashi et al., (see Igarashi, T., Matsuoka, S., and Tanaka, H., 1999, Teddy: A sketching interface for 3D freeform design, ACM Siggraph 1999, pp 409-416). The modified procedure may add an additional protruded part to an original three-dimensional shape and obtains two-dimensional patterns corresponding to the additional protruded part in response to the user's entry of a linear baseline or a baseline of a predetermined planar shape in the original three-dimensional image.

(3D/2D Dragging Routine)

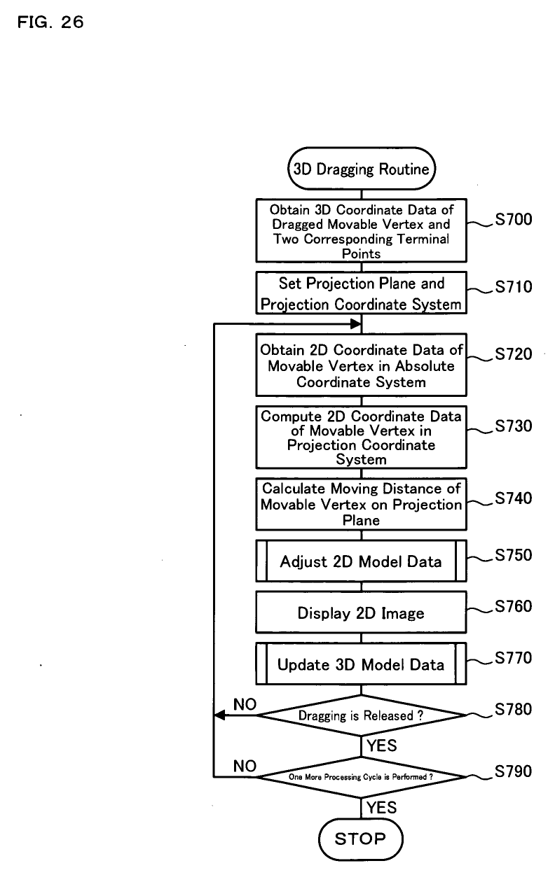

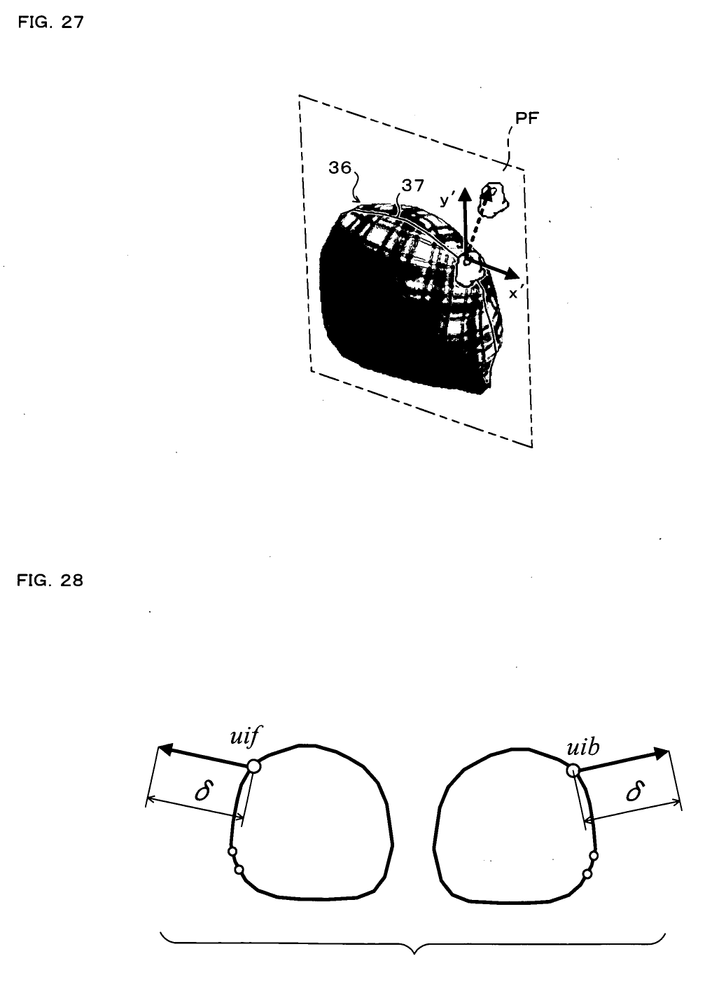

FIG. 26 is a flowchart showing a 3D dragging routine executed by the computer 20 of the embodiment. The 3D dragging routine is triggered in response to the user's operation of the mouse 50 and the stylus 60 for moving a selected vertex included in the connection lines of the two-dimensional patterns 34 or a selected vertex of polygon meshes forming a seam line 37 in the three-dimensional image 36, which is displayed in the 3D image display area 33 by execution of the basic processing routine at least once. Here this vertex as the object of 3D dragging is referred to as ‘movable vertex’. In this embodiment, an identifier representing formation of the seam line 37 is allocated to three-dimensional model data of the movable vertex included in the seam line 37 of the three-dimensional image 36. When the user moves the cursor to the movable vertex on the 3D image display area 33, the cursor changes its shape from an arrow shape to a hand shape as shown in FIG. 27. In response to the user's right click of the mouse 50 during the display of the cursor in the hand shape, the movable vertex as the object of 3D dragging can be dragged and moved.

At the start of the 3D dragging routine of FIG. 26, the coordinate processing unit 21 extracts three-dimensional coordinate data of a dragged movable vertex and two terminal points of a seam line 37 including the movable vertex from the 3D data storage module 26 (step S700). The coordinate setting module 21a of the coordinate processing unit 21 subsequently sets a projection plane based on the three-dimensional coordinate data of the dragged movable vertex and the two terminal points and sets a two-dimensional projection coordinate system for the projection plane (step S710). The projection plane set at step S710 is a virtual plane PF including the dragged movable vertex and the two terminal points, based on three-dimensional coordinate data of the movable vertex and the two terminal points immediately before the user's dragging and moving operation. The projection coordinate system set at step S710 is defined by a vertical axis (y′ axis) as a straight line extended in a normal direction of the movable vertex immediately before the user's dragging and moving operation and a horizontal axis (x′ axis) as a straight line extended perpendicular to the vertical axis as shown in FIG. 27. The coordinate processing unit 21 subsequently extracts two-dimensional coordinate data of the movable vertex in the X-Y coordinate system of the three-dimensional absolute coordinate system set in the 3D image display area 33 on the display device 30 (step S720). The coordinate operator 21b of the coordinate processing unit 21 computes two-dimensional coordinate data of the movable vertex in the projection coordinate system in projection of the two-dimensional coordinates of the movable vertex obtained at step S720 onto the projection plane set at step S710 and stores the computed two-dimensional coordinate data of the projected movable vertex into the 2D data storage module 25 (step S730).

The 2D model data regulator 23 then calculates a moving distance δ of the movable vertex on the projection plane, based on the two-dimensional coordinate data of the movable vertex in the projection coordinate system computed at step S730 (step S740). The moving distance δ is readily calculable as a distance of the two-dimensional coordinates of the movable vertex in the projection coordinate system computed at step S730 from the origin of the projection coordinate system. After calculation of the moving distance δ, at step S750, the 2D model data regulator 23 computes two-dimensional coordinate data of vertexes uif and uib of two-dimensional patterns 34 (polygon meshes) corresponding to the dragged movable vertex after motions of these vertexes uif and uib in their respective normal directions by the moving distance δ calculated at step S740 as shown in FIG. 28. At step S750, the 2D model data regulator 23 subsequently performs a predetermined smoothing operation with regard to all vertexes constituting the outer circumferences (connection lines) of the two-dimensional patterns 34 including the respective vertexes uif and uib, in order to smooth the outer circumferences (contours) of the two-dimensional patterns 34. For example, a two-dimensional transformation technique proposed by Igarashi et al. may be adopted for smoothing (see Igarashi, T., Moscovich, T., and Hughes, J. F., 2005, As-rigid-as-possible shape manipulation, ACM Transactions on Computer Graphics (In ACM Siggrah 2005), 24(3), pp 1134-1141). The 2D model data regulator 23 then adjusts and updates the two-dimensional model data representing the information on the X-Y coordinates of vertexes of all the polygon meshes, a starting point and an end point of each edge interconnecting each pair of the vertexes, and the length of each edge at step S750.

After the adjustment and the update of the two-dimensional model data, the 2D image display controller 28 displays two-dimensional patterns 34 in the 2D image display area 32 based on the adjusted two-dimensional model data (step S760). The 2D/3D modeling unit 22 updates the three-dimensional model data based on the two-dimensional model data adjusted and updated at step S750 (step S770). According to a concrete procedure of step S770, the 2D/3D modeling unit 22 recalculates the three-dimensional coordinate data of the respective vertexes to make the length of each edge of the polygon meshes defined by the three-dimensional model data substantially equal to the length of a corresponding edge defined by the two-dimensional model data adjusted and updated at step S750, specifies the information on the respective edges based on the result of the recalculation, and stores the specified information as updated three-dimensional model data into the 3D data storage module 26. After the update at step S770, it is determined whether the user's dragging of the movable vertex is released (step S780). When the user continues the dragging of the movable vertex, the 3D dragging routine repeats the processing of and after step S720. Upon determination at step S780 that the user releases the dragging of the movable vertex, on the other hand, it is determined whether one more cycle of the processing of and after step S720 is performed after the release of the dragging (step S790). In the case of a negative answer at step S790, the 3D dragging routine performs one more cycle of the processing of and after step S720. The 3D dragging routine is terminated in response to an affirmative answer at step S790.

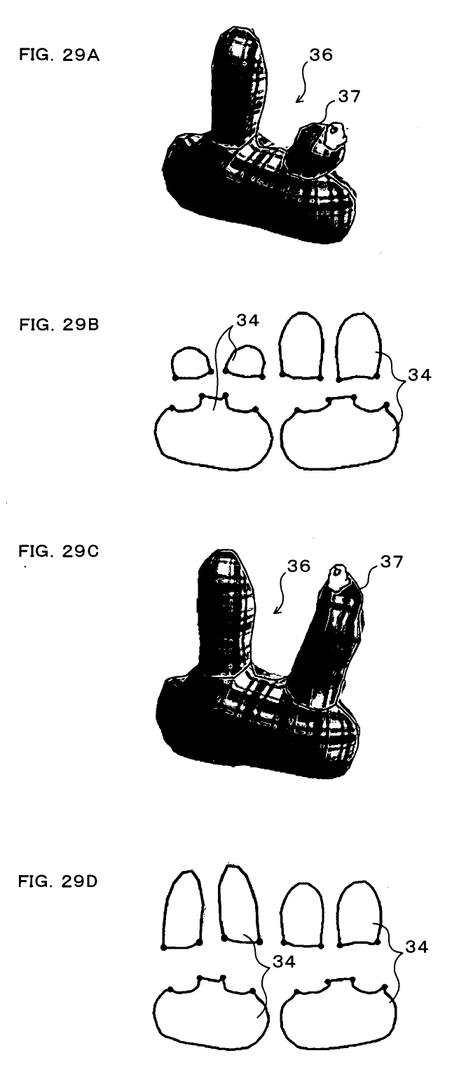

As described above, in the computer 20 of the embodiment with the three-dimensional shape conversion program installed therein, in response to the user's operation of the mouse 50 and the stylus 60 to move a movable vertex on the seam line 37 of the three-dimensional image 36 displayed in the 3D image display area 33, the coordinate processing unit 21 obtains two-dimensional coordinate data of the movable vertex in the projection coordinate system set for the projection plane (step S730). Here the projection plane is based on the movable vertex as the object of the dragging and moving operation and two terminal points of the seam line 37 (connection line) including the movable vertex. The 2D model data regulator 23 calculates the moving distance δ of the movable vertex on the projection plane based on the two-dimensional coordinate data obtained at step S730 (step S740), and adjusts the two-dimensional model data to reflect the motions of the vertexes of the polygon meshes corresponding to the dragged movable vertex by the calculated moving distance δ in their respective normal directions (step S750). The 2D/3D modeling unit 22 updates the three-dimensional model data based on the adjusted two-dimensional model data (step S770). The user of the computer 20 can readily alter and modify the displayed three-dimensional shape to be closer to the user's desired shape and obtain the two-dimensional patterns 34 corresponding to the altered and modified three-dimensional shape by the simple operation of the mouse 50 and the stylus 60 for dragging the movable vertex on the 3D image display area 33 as shown in FIGS. 29A, 29B, 29C, and 29D.

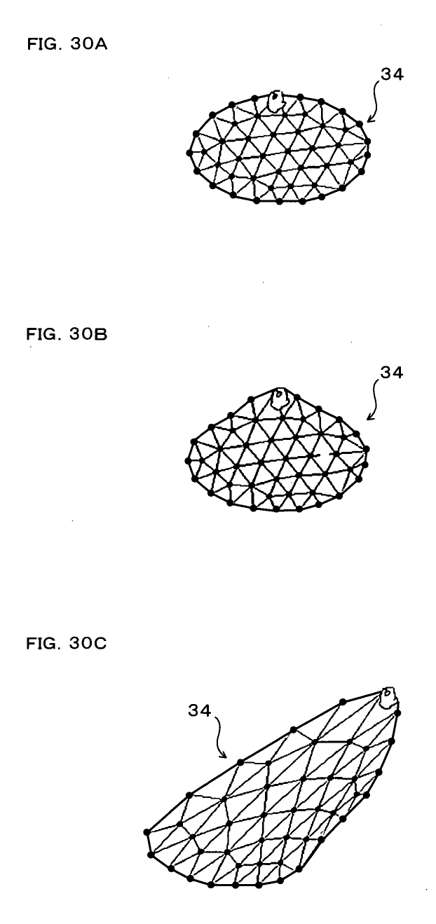

The 3D dragging routine of FIG. 26 is triggered in response to the user's dragging and moving operation of the movable vertex on the 3D image display area 33. In this embodiment, a 2D dragging routine (not shown) similar to the 3D dragging routine of FIG. 26 is also performed in response to the user's operation of the mouse 50 and the stylus 60 to move a selected vertex (movable vertex) included in the outer circumferences (connection lines) of the two-dimensional patterns 34 displayed in the 2D image display area 32 as shown in FIGS. 30A, 30B, and 30C. For the clarity of explanation, FIGS. 30A, 30B, and 30C show the two-dimensional patterns 34 as the mesh models. In this embodiment, an identifier representing formation of the outer circumferences is allocated to two-dimensional model data of the movable vertex included in the outer circumferences of the two-dimensional patterns 34. When the user moves the cursor to the movable vertex on the 2D image display area 32, the cursor changes its shape from the arrow shape to the hand shape as shown in FIGS. 30A, 30B, and 30C. In response to the user's right click of the mouse 50 during the display of the cursor in the hand shape, the movable vertex as the object of 2D dragging can be dragged and moved. At the start of the 2D dragging routine, the coordinate processing unit 21 obtains two-dimensional coordinate data of the movable vertex in an X-Y coordinate system set in the 2D image display area 32. The 2D model data regulator 23 adjusts the two-dimensional model data to reflect a motion of the movable vertex from its original position to a target position based on the obtained two-dimensional coordinate data. The 2D/3D modeling unit 22 then updates the three-dimensional model data based on the adjusted two-dimensional model data. The user of the computer 20 can readily alter and modify the shape of the displayed two-dimensional pattern 34 to be closer to the user's desired shape and obtain a three-dimensional shape corresponding to the altered and modified two-dimensional pattern 34 by the simple operation of the mouse 50 and the stylus 60 for dragging the movable vertex on the 2D image display area 32.

(Seam Addition Routine)

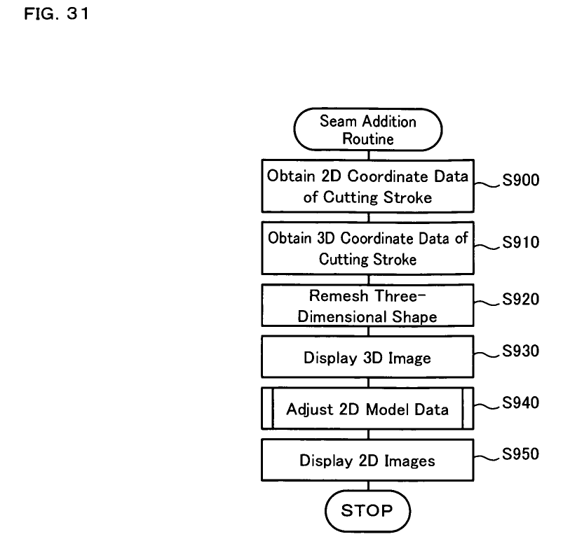

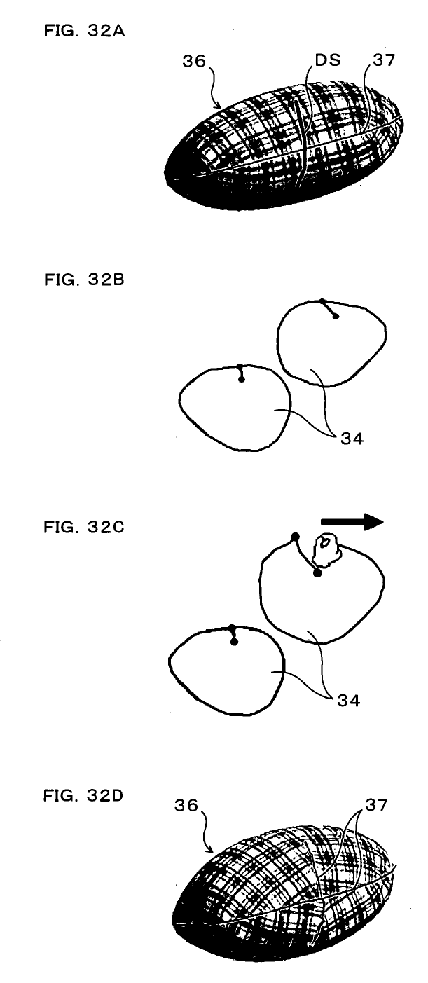

FIG. 31 is a flowchart showing a seam addition routine executed by the computer 20 of the embodiment. The seam addition routine is triggered in response to the user's operation of the mouse 50 and the stylus 60 for the entry of a cutting stroke DS that has a starting point and an end point on or inside of the outer circumference of the three-dimensional image 36 and is wholly located inside the outer circumference of the three-dimensional image 36, which is displayed in the 3D image display area 33 by execution of the basic processing routine at least once, as shown in FIG. 32A. At the start of the seam addition routine of FIG. 31, the coordinate processing unit 21 of the computer 20 extracts the coordinates of respective points constituting the input cutting stroke DS in the X-Y coordinate system of the three-dimensional absolute coordinate system set in the 3D image display area 33 on the display device 30 and stores X-Y coordinates of specific discrete points arranged at preset intervals between the starting point and the end point of the cutting stroke DS, among the extracted coordinates of the respective points, as two-dimensional coordinate data regarding vertexes of the cutting stroke DS into the 2D data storage module 25 (step S900). The coordinate operator 21b of the coordinate processing unit 21 refers to the two-dimensional coordinate data of the vertexes in the cutting stroke DS extracted and stored at step S900 and the three-dimensional model data (three-dimensional coordinates of the respective vertexes of the polygon meshes) stored in the 3D data storage module 26, computes coordinates (three-dimensional coordinates) of intersections of straight lines extended in the Z-axis direction (in the user's view direction) through the respective vertexes of the cutting stroke DS and mesh planes defined by the three dimensional model data, and stores the computed coordinates as three-dimensional coordinate data of the vertexes constituting the cutting stroke DS into the 3D data storage module 26 (step S910).

The 2D/3D modeling unit 22 remeshes the three-dimensional shape defined by the three-dimensional model data stored in the 3D data storage module 26 to form a cutting line in the three-dimensional shape at a position corresponding to the cutting stroke DS, based on the three-dimensional coordinate data of the vertexes in the cutting stroke DS computed and stored at step S910 (step S920). The remeshed and updated three-dimensional model data is stored in the 3D data storage module 26. The 3D image display controller 29 then displays an updated three-dimensional image 36 in the 3D image display area 33, based on the updated and stored three-dimensional model data (step S930). The 2D model data regulator 23 adjusts the two-dimensional model data based on the three-dimensional model data updated at step S920 and stores the adjusted two-dimensional model data into the 2D data storage module 25 (step S940). The procedure of this embodiment adopts a two-dimensional development technique proposed by Sheffer et al. (see Sheffer, A., Levy, B., Mogilnitsky, M., and Bogomyakov, A., 2005, ABF++: Fast and robust angle-based flattening, ACM Transactions on Graphics, 24 (2), pp 311-330) for generation of two-dimensional model data from three-dimensional model data. The 2D image display controller 28 displays two-dimensional patterns 34 in the 2D image display area 32 based on the two-dimensional model data (step S950). The seam addition routine is then terminated.

As described above, in the computer 20 of the embodiment with the three-dimensional shape conversion program installed therein, in response to the user's operation of the mouse 50 and the stylus 60 for the entry of a cutting stroke DS that has a starting point and an end point on or inside of the outer circumference of the three-dimensional image 36 and is wholly located inside the outer circumference of the three-dimensional image 36 displayed in the 3D image display area 33, the 2D/3D modeling unit 22 updates the three-dimensional model data to form a cutting line in the three-dimensional shape at a position corresponding to the cutting stroke DS (step S920). The 2D model data regulator 23 subsequently adjusts the two-dimensional model data based on the updated three-dimensional model data (step S940). The user can add new connection lines corresponding to the cutting stroke DS to the two-dimensional patterns 34 and thereby change the three-dimensional shape by the simple entry of the cutting stroke DS to make a slit in the three-dimensional image 36 displayed in the 3D image display area 33. In response to the user's entry of the cutting stroke DS, new connection lines are formed to be extended inward from the outer circumferences of the two-dimensional patterns 34 as shown in FIG. 32B. In this case, among the respective vertexes constituting the connection lines, each of the vertexes other than inner-most terminal points of the two-dimensional patterns 34 is assumed to consist of perfectly-overlapped two vertexes. A selected vertex (movable vertex) included in the new connection lines corresponding to the cutting stroke DS is then movable on the 2D image display area 32. A motion of a selected vertex (movable vertex) included in the new connection lines on the 2D image display area 32 as shown in FIG. 32C enables a minute change of the three-dimensional shape as shown in FIG. 32D.

In the embodiment described above, the three-dimensional shape conversion program is installed in one single computer 20. This configuration is, however, not essential but may be modified in various ways. The three-dimensional shape conversion program may be divided into two modules, a module of performing three-dimensional data-related operations, such as the three-dimensional modeling and the three-dimensional image display control and a module of performing two-dimensional data-related operations, such as the adjustment of two-dimensional model data and the two-dimensional image display control. These two modules may be separately installed in two different but mutually communicable computers. This arrangement desirably enhances the processing speeds of modeling a three-dimensional image and of generating two-dimensional patterns. In the embodiment described above, one display device 30 is connected to the computer 20, and the 2D image display area 32 and the 3D image display area 33 are shown on the display screen 31 of the display device 30. In one modified arrangement, two display devices 30 may be connected to the computer 20. The 2D image display area 32 is shown on the display screen 31 of one display device 30, whereas the 3D image display area 33 is shown on the display screen 31 of the other display device 30.

The embodiment and its modified examples discussed above are to be considered in all aspects as illustrative and not restrictive. There may be many other modifications, changes, and alterations without departing from the scope or spirit of the main characteristics of the present invention. Industrial Applicability

The technique of the present invention is preferably applied in the field of information processing.

The disclosure of Japanese Patent Application No. 2007-204018 filed Aug. 6, 2007 including specification, drawings and claims is incorporated herein by reference in its entirety.

What is claimed is:

1. A three-dimensional shape conversion system constructed to convert a three-dimensional shape into two dimensions, the three-dimensional shape conversion system comprising:
an input unit configured to input a contour of a three-dimensional shape;
a coordinate acquisition module configured to obtain two-dimensional coordinate data of the contour input via the input module;
a two-dimensional modeling module configured to perform two-dimensional modeling based on the obtained two-dimensional coordinate data and thereby generate two-dimensional model data regarding a two-dimensional pattern defined by the two-dimensional coordinate data;
a three-dimensional modeling module configured to perform three-dimensional modeling based on the generated two-dimensional model data and thereby generate three-dimensional model data regarding a three-dimensional shape obtained by expanding the two-dimensional pattern defined by the two-dimensional model data; and
a two-dimensional model data regulator configured to adjust the generated two-dimensional model data, in order to make a corresponding contour of the three-dimensional shape defined by the three-dimensional model data substantially consistent with the input contour.

2. The three-dimensional shape conversion system in accordance with claim 1, wherein the adjustment of the two-dimensional model data by the two-dimensional model data regulator and update of the three-dimensional model data based on the adjusted two-dimensional model data by the three-dimensional modeling module are repeated until the corresponding contour of the three-dimensional shape defined by the three-dimensional model data becomes basically consistent with the input contour.

3. The three-dimensional shape conversion system in accordance with claim 1, wherein the two-dimensional modeling module generates two-dimensional model data with regard to a pair of two-dimensional patterns as two opposed sides relative to the input contour, and the three-dimensional modeling module generates three-dimensional model data regarding a three-dimensional shape obtained by expanding the pair of two-dimensional patterns with joint of corresponding outer circumferences.

4. The three-dimensional shape conversion system in accordance with claim 1, wherein the coordinate acquisition module obtains two-dimensional coordinate data of each tentative vertex included in the corresponding contour of the three-dimensional shape defined by the three-dimensional model data in a predetermined two-dimensional coordinate system, and
the two-dimensional model data regulator includes:
a projection component length computation module configured to compute a projection component length of each vector, which connects each target vertex included in the input contour with a corresponding tentative vertex corresponding to the target vertex, in a normal direction of the tentative vertex, based on two-dimensional coordinate data of the tentative vertex and the target vertex; and
a coordinate computation module configured to compute coordinates of each object vertex included in a contour of the two-dimensional pattern defined by the two-dimensional model data after a motion of the object vertex in a normal direction of the object vertex by the computed projection component length.

5. The three-dimensional shape conversion system in accordance with claim 4, the three-dimensional shape conversion system further including: a detection module configured to compare a sum of the projection component lengths with regard to all the tentative vertexes with a preset reference value and, when the sum becomes not greater than the preset reference value, detect a consistency of the corresponding contour of the three-dimensional shape defined by the three-dimensional model data with the input contour.

6. The three-dimensional shape conversion system in accordance with claim 1, wherein the two-dimensional modeling module divides the two-dimensional pattern defined by the two-dimensional coordinate data of the input contour into polygon meshes, and outputs coordinates of respective vertexes of the polygon meshes and length of each edge interconnecting each pair of the vertexes as the two-dimensional model data.

7. The three-dimensional shape conversion system in accordance with claim 6, wherein the three-dimensional modeling module computes coordinates of each vertex of the polygon meshes and the length of each edge interconnecting each pair of the vertexes based on the two-dimensional model data when a mesh plane formed by each edge of the polygon meshes is moved outward in a normal direction of the mesh plane under a predetermined moving restriction in the normal direction of the mesh plane and under a predetermined expansion-contraction restriction of restricting at least expansion of each edge of the polygon meshes, and outputs the computed coordinates and the computed length of each edge as the three-dimensional model data.

8. The three-dimensional shape conversion system in accordance with claim 7, wherein the predetermined moving restriction sets a moving distance Δdf of a specific vertex Vi according to Equation (1) given below:
$$Δ df = α \cdot \frac{{\sum }_{f ∈ Ni} A ( f ) \cdot n ( f )}{{\sum }_{f ∈ N} A ( f )} \qquad ( 1 )$$
where A(f), n(f), and Ni respectively denote an area of a mesh plane f, a normal vector of the mesh plane f, and a set of mesh planes including the specific vertex Vi, and a represents a preset coefficient,
the predetermined expansion-contraction restriction sets a moving distance Δde of the specific vertex Vi according to Equation (2) given below:
$$Δ de = β \cdot \frac{{\sum }_{eij ∈ Ei} \{ A ( e . leftface ) + A ( e . rightface ) \} \cdot {t}_{ij}}{{\sum }_{eij ∈ Ei} \{ A ( e . leftface ) + A ( e . rightface ) \}} \qquad ( 2 )$$
where Vj, eij, Eij, A(e,leftface), A(e,rightface), and tij respectively denote a vertex connected with the specific vertex Vi by means of an edge, an edge interconnecting the specific vertex Vi with the vertex Vj, a set of edges eij intersecting the specific vertex Vi, an area of a plane located on the left of the edge eij, an area of a plane located on the right of the edge eij, and a pulling force applied from the edge eij to the vertexes Vi and Vj, β represents a preset coefficient, and the pulling force tij is defined according to Equation (3) given below:
$${t}_{ij} = \{ \begin{matrix}0.5 \cdot ( vj - vi ) \cdot \frac{\vert vi - vj \vert - {l}_{ij}}{\vert vi - vj \vert} & … & if \vert vi - vj \vert \geq {l}_{ij} \\ 0 & … & if \vert vi - vj \vert < {l}_{ij}\end{matrix} \} \qquad ( 3 )$$
where lij denotes an original edge length, and
the three-dimensional modeling module computes three-dimensional coordinate data when all vertexes Vi are moved by the moving distance Δdf set according to Equation (1) given above and are further moved at least once by the moving distance Δde set according to Equation (2) given above.

9. The three-dimensional shape conversion system in accordance with claim 1, the three-dimensional shape conversion system further including:
a three-dimensional image display unit configured to display a three-dimensional image on a window thereof;
a two-dimensional image display unit configured to display a two-dimensional image on a window thereof;
a three-dimensional image display controller configured to control the three-dimensional image display unit to display a three-dimensional image representing the three-dimensional shape on the window, based on the three-dimensional model data; and
a two-dimensional image display controller configured to control the two-dimensional image display unit to display a two-dimensional image representing the two-dimensional pattern on the window, based on the two-dimensional model data generated by the two-dimensional modeling module or the two-dimensional model data adjusted by the two-dimensional model data regulator.

10. The three-dimensional shape conversion system in accordance with claim 9, wherein in response to an operation of the input unit for entry of a cutoff stroke that intersects an outer circumference of the three-dimensional image displayed on the window of the three-dimensional display unit at two different points and cuts off part of the three-dimensional image, the three-dimensional modeling module generates the three-dimensional model data to reflect a split of the three-dimensional shape defined by the three-dimensional model data by a developable surface obtained by sweep of the cutoff stroke in a specified direction to leave one side area of the developable surface remain but to eliminate the other side area of the developable surface, and
the two-dimensional model data regulator adjusts the two-dimensional model data corresponding to the remaining side area of the developable surface based on the generated three-dimensional model data.

11. The three-dimensional shape conversion system in accordance with claim 10, wherein the three-dimensional modeling module generates three-dimensional model data regarding a three-dimensional shape obtained by expanding a two-dimensional pattern based on the two-dimensional model data adjusted corresponding to the remaining side area of the developable surface, and
the adjustment of the two-dimensional model data by the two-dimensional model data regulator and update of the three-dimensional model data based on the adjusted two-dimensional model data by the three-dimensional modeling module are repeated until a contour corresponding to the cutoff stroke in the three-dimensional shape by the generated three-dimensional model data becomes basically consistent with the input cutoff stroke.

12. The three-dimensional shape conversion system in accordance with claim 9, wherein in response to an operation of the input unit for entry of an additional stroke that has a starting point and an end point on or inside of an outer circumference of the three-dimensional image displayed on the window of the three-dimensional display unit and is protruded outward from the outer circumference of the three-dimensional image, the three-dimensional modeling module generates the three-dimensional model data to reflect formation of a predetermined baseline passing through the starting point and the end point of the input additional stroke,
the coordinate acquisition module obtains two-dimensional coordinate data of a vertex included in the additional stroke in a predetermined two-dimensional coordinate system set on a preset virtual plane including the starting point and the endpoint of the additional stroke, while obtaining two-dimensional coordinate data of a vertex included in the baseline in projection onto the virtual plane, and
the two-dimensional model data regulator adjusts the two-dimensional model data corresponding to the additional stroke and the baseline, based on the obtained two-dimensional coordinate data of the vertex included in the additional stroke and the obtained two-dimensional coordinate data of the vertex included in the baseline.

13. The three-dimensional shape conversion system in accordance with claim 12, wherein the baseline is a line included in a line of intersection between a surface of the three-dimensional shape and the virtual plane and extended from the starting point to the end point of the additional stroke.

14. The three-dimensional shape conversion system in accordance with claim 12, wherein the baseline is a closed line including the starting point and the endpoint of the additional stroke and forming a predetermined planar shape.

15. The three-dimensional shape conversion system in accordance with claim 12, wherein the three-dimensional modeling module generates three-dimensional model data regarding a three-dimensional shape obtained by expanding a two-dimensional pattern based on the two-dimensional model data adjusted corresponding to the additional stroke and the baseline, and
the adjustment of the two-dimensional model data by the two-dimensional model data regulator and update of the three-dimensional model data based on the adjusted two-dimensional model data by the three-dimensional modeling module are repeated until a contour corresponding to the additional stroke in the three-dimensional shape defined by the three-dimensional model data becomes basically consistent with the input additional stroke.

16. The three-dimensional shape conversion system in accordance with claim 9, the three-dimensional shape conversion system further including:
a three-dimensional image manipulation unit operated to move a movable vertex, which is a vertex included in a seam line corresponding to connection lines of multiple two-dimensional patterns, on the window of the three-dimensional image display unit,
wherein the coordinate acquisition module obtains two-dimensional coordinate data of the movable vertex in a predetermined two-dimensional coordinate system set on a preset virtual plane based on the movable vertex and the seam line including the movable vertex, when the movable vertex is moved on the window of the three-dimensional image display unit by an operation of the three-dimensional image manipulation unit,
the two-dimensional model data regulator calculates a moving distance of the movable vertex on the virtual plane based on the two-dimensional coordinate data, and adjusts the two-dimensional model data to reflect a motion of a specific vertex, which is included in the connection lines and corresponds to the movable vertex, in a normal direction of the specific vertex by the calculated moving distance, and
the three-dimensional modeling module updates the three-dimensional model data based on the adjusted two-dimensional model data.

17. The three-dimensional shape conversion system in accordance with claim 9, the three-dimensional shape conversion system further including:
a two-dimensional image manipulation unit operated to move a movable vertex, which is a vertex included in an outer circumference of the two-dimensional pattern, on the window of the two-dimensional image display unit,
wherein the coordinate acquisition module obtains two-dimensional coordinate data of the movable vertex in a predetermined two-dimensional coordinate system, when the movable vertex is moved on the window of the two-dimensional image display unit by an operation of the two-dimensional image manipulation unit,
the two-dimensional model data regulator adjusts the two-dimensional model data to reflect a motion of the movable vertex from its original position to a position specified by the obtained two-dimensional coordinate data, and
the three-dimensional modeling module updates the three-dimensional model data based on the adjusted two-dimensional model data.

18. The three-dimensional shape conversion system in accordance with claim 9, wherein in response to an operation of the input unit for entry of a cutting stroke that has a starting point and an end point on or inside of an outer circumference of the three-dimensional image displayed on the window of the three-dimensional image display unit and is wholly located inside the outer circumference of the three-dimensional image, the three-dimensional modeling module updates the three-dimensional model data to reflect formation of a cutting line at a position corresponding to the cutting stroke, and
the two-dimensional model data regulator adjusts the two-dimensional model data based on the updated three-dimensional model data.

19. A three-dimensional shape conversion method of converting a three-dimensional shape into two dimensions, the three-dimensional shape conversion method comprising the steps of:
(a) obtaining two-dimensional coordinate data of a contour of a three-dimensional shape input by an operation of an input unit;
(b) performing two-dimensional modeling based on the obtained two-dimensional coordinate data and thereby generating two-dimensional model data regarding a two-dimensional pattern defined by the two-dimensional coordinate data;
(c) performing three-dimensional modeling based on the generated two-dimensional model data and thereby generating three-dimensional model data regarding a three-dimensional shape obtained by expanding the two-dimensional pattern defined by the two-dimensional model data; and
(d) adjusting the generated two-dimensional model data, in order to make a corresponding contour of the three-dimensional shape defined by the three-dimensional model data substantially consistent with the input contour.

20. The three-dimensional shape conversion method in accordance with claim 19, wherein the step (d) of adjusting the two-dimensional model data and step (e) of updating the three-dimensional model data based on the two-dimensional model data adjusted in the step (d) are repeated until the corresponding contour of the three-dimensional shape defined by the three-dimensional model data becomes basically consistent with the input contour.

21. A three-dimensional shape conversion program executed to enable a computer to function as a three-dimensional shape conversion system of converting a three-dimensional shape into two dimensions, the three-dimensional shape conversion program comprising:
a coordinate acquisition module configured to obtain two-dimensional coordinate data of a contour of a three-dimensional shape input by an operation of an input unit;
a two-dimensional modeling module configured to perform two-dimensional modeling based on the obtained two-dimensional coordinate data and thereby generate two-dimensional model data regarding a two-dimensional pattern defined by the two-dimensional coordinate data;
a three-dimensional modeling module configured to perform three-dimensional modeling based on the generated two-dimensional model data and thereby generate three-dimensional model data regarding a three-dimensional shape obtained by expanding the two-dimensional pattern defined by the two-dimensional model data; and
a two-dimensional model data adjustment module configured to adjust the generated two-dimensional model data, in order to make a corresponding contour of the three-dimensional shape defined by the three-dimensional model data substantially consistent with the input contour.
